(19) United States
(12) Patent Application Publication
(10) Pub. No.: US 2026/0319466 A1
(43) Pub. Date: Oct. 15, 2026

(54) MACHINING PROCESS DEVELOPMENT SUPPORT DEVICE, MACHINING PROCESS DEVELOPMENT SUPPORT SYSTEM, MACHINING SYSTEM, MACHINING PROCESS DEVELOPMENT SUPPORT METHOD, AND MACHINING METHOD

(71) Applicant: Mitsubishi Electric Corporation, Tokyo (JP)

(72) Inventors: Claire-Amelie JANOT, Tokyo (JP); Kenta HAMADA, Tokyo (JP); Akira MIYATA, Tokyo (JP)

(73) Assignee: Mitsubishi Electric Corporation, Tokyo (JP)

(21) Appl. No.: 19/481,198

(22) PCT Filed: May 19, 2023
(86) PCT No.: PCT/JP2023/018794

§ 371 Date: Nov. 4, 2025

(51) Int. Cl. G05B 19/4155

(52) U.S. Cl. CPC G05B 19/4155; G05B 2219/49038

(57) ABSTRACT

A machining process development support device includes a shape input unit that accepts input of shape data of a blank shape and a final product shape, a remaining region extraction unit that extracts remaining regions that are regions to be machined based on the blank shape and the final product shape input through the shape input unit, a remaining region division unit that divides the remaining regions extracted by the remaining region extraction unit into a plurality of machining regions, a machining process development unit that supports development of machining processes that machine the machining regions based on the shape information of the machining regions formed by the remaining region division unit, and a machining process output unit that outputs, as a machining program, the machining processes developed with the support of the machining process development unit.

### TECHNICAL FIELD

The present disclosure relates to a machining process development support device that supports development of a machining process, a machining process development support system, a machining system, a machining process development support method, and a machining method.

### BACKGROUND ART

In a machining device in which a numerical control device is mounted, the numerical control device executes a machining program so as to machine a material called a workpiece in a desired final product shape. The machining program includes, for example, a plurality of G codes. Note that the numerical control device is also referred to as an NC device.

In recent years, a technique has been known that creates a machining program using computer aided design (CAD) data in order to easily create the machining program (for example, refer to PTL 1).

The numerical control device described in PTL 1 is a device that generates a machining program using CAD data. The numerical control device described in PTL 1 extracts a shape that can be machined using a tool, from the CAD data, based on information regarding the tool selected by a user. Next, the numerical control device described in PTL 1 extracts one or more G codes that can be used to machine the workpiece, for the shape extracted from the CAD data. The user selects one G code from among the one or more extracted G codes. Moreover, the user inputs values of parameters, for example, a thickness, a depth, a length, or the like of the shape that are information necessary for machining. The numerical control device described in PTL 1 generates each block of the G code using the value of the parameter input by the user and sequentially adds the generated blocks of the G code so as to create the machining program.

### CITATION LIST

### Patent Literature

PTL 1: International Publication Pamphlet No. WO 2022/091896

### SUMMARY OF INVENTION

### Technical Problem

However, with the numerical control device described in PTL 1 described above, the user needs to manually select a tool based on a shape, a position, or the like of a machining region to be machined, manually select one G code from among extracted G codes, and manually input a value of a parameter, and a load of the user has been large.

Moreover, when generating a machining program, the numerical control device described in PTL 1 described above uses only CAD data of a final product shape and does not consider a shape of a material called a workpiece (hereinafter, referred to as blank shape). Therefore, the automatically generated machining program cannot be used as it is, and the user needs to manually edit the machining program again based on the blank shape. Furthermore, there has been a case where it is difficult for an inexperienced user to perform appropriate edition.

The present disclosure has been made to solve the above problems, and an object of the present disclosure is to obtain a machining process development support device that can easily generate a machining program.

### Solution to Problem

On order to solve the above problems and achieve the object, the present disclosure is a machining process development support device including a shape input unit that accepts input of shape data of a blank shape and a final product shape, a remaining region extraction unit that extracts remaining regions that are regions to be machined based on the blank shape and the final product shape input through the shape input unit, a remaining region division unit that divides the remaining regions extracted by the remaining region extraction unit into a plurality of machining regions, a machining process development unit that supports development of machining processes that machine the machining regions based on shape information of the machining region formed by the remaining region division unit, and a machining process output unit that outputs as a machining program the machining processes developed with the support of the machining process development unit.

### Advantageous Effects of Invention

According to a machining process development support device according to the present disclosure, it is possible to achieve an effect of realizing easy generation of a machining program.

### BRIEF DESCRIPTION OF DRAWINGS

FIG. 1 is a block diagram illustrating a configuration of a machining process development support device according to a first embodiment.

FIG. 2 is a block diagram illustrating a configuration of a machining process development support system and a machining system according to the first embodiment.

FIG. 3 is a diagram illustrating an example of a blank shape, a final product shape, and an initial remaining region in the machining process development support device according to the first embodiment.

FIG. 4 is a flowchart illustrating a procedure for dividing the remaining region by a remaining region division unit provided in the machining process development support device according to the first embodiment.

FIG. 5 is a diagram illustrating an example of the procedure for dividing the remaining region by the remaining region division unit provided in the machining process development support device according to the first embodiment.

FIG. 6 is a diagram illustrating an example of a machining region and a machining process of the machining process development support device according to the first embodiment.

FIG. 7 is a diagram illustrating an example of the machining region and the machining process of the machining process development support device according to the first embodiment.

FIG. 8 is a diagram illustrating an example of the machining region and the machining process of the machining process development support device according to the first embodiment.

FIG. 9 is a flowchart illustrating a procedure of development support processing of a machining process by a machining process development unit provided in the machining process development support device according to the first embodiment.

FIG. 10 is a diagram illustrating an example of a data table of machining process information of the machining process development support device according to the first embodiment.

FIG. 11 is a diagram illustrating an example of a tool data table of the machining process development support device according to the first embodiment.

FIG. 12 is a diagram illustrating an example of a machining program generated by the machining process development support device according to the first embodiment.

FIG. 13 is a perspective view illustrating an example of the blank shape and the final product shape in the machining process development support device according to the first embodiment.

FIG. 14 is a cross-sectional view illustrating an example of the blank shape and the final product shape in the machining process development support device according to the first embodiment.

FIG. 15 is a front view illustrating an example of a display screen of a user interface of a GUI unit of the machining process development support device according to the first embodiment.

FIG. 16 is a front view illustrating an example of the display screen of the user interface of the GUI unit of the machining process development support device according to the first embodiment.

FIG. 17 is a diagram illustrating an example in which the initial remaining region in the machining process development support device according to the first embodiment is divided into a plurality of sub-remaining regions.

FIG. 18 is a front view illustrating an example of the display screen of the user interface of the GUI unit of the machining process development support device according to the first embodiment.

FIG. 19 is a front view illustrating an example of the display screen of the user interface of the GUI unit of the machining process development support device according to the first embodiment.

FIG. 20 is a front view illustrating an example of the display screen of the user interface of the GUI unit of the machining process development support device according to the first embodiment.

FIG. 21 is a front view illustrating an example of the display screen of the user interface of the GUI unit of the machining process development support device according to the first embodiment.

FIG. 22 is a front view illustrating an example of the display screen of the user interface of the GUI unit of the machining process development support device according to the first embodiment.

FIG. 23 is a front view illustrating an example of the display screen of the user interface of the GUI unit of the machining process development support device according to the first embodiment.

FIG. 24 is a front view illustrating an example of the display screen of the user interface of the GUI unit of the machining process development support device according to the first embodiment.

FIG. 25 is a front view illustrating an example of the display screen of the user interface of the GUI unit of the machining process development support device according to the first embodiment.

FIG. 26 is a front view illustrating an example of the display screen of the user interface of the GUI unit of the machining process development support device according to the first embodiment.

FIG. 27 is a front view illustrating an example of the display screen of the user interface of the GUI unit of the machining process development support device according to the first embodiment.

FIG. 28 is a front view illustrating an example of the display screen of the user interface of the GUI unit of the machining process development support device according to the first embodiment.

FIG. 29 is a front view illustrating an example of the display screen of the user interface of the GUI unit of the machining process development support device according to the first embodiment.

FIG. 30 is a diagram illustrating a hardware configuration for implementing the machining process development support device according to the first embodiment.

FIG. 31 is a flowchart illustrating a flow of processing of a machining process development support method according to the first embodiment.

FIG. 32 is a flowchart illustrating a flow of processing of a machining method according to the first embodiment.

### DESCRIPTION OF EMBODIMENTS

Hereinafter, a machining process development support device, a machining process development support system, a machining system, a machining process development support method, and a machining method according to an embodiment of the present disclosure will be described in detail with reference to the drawings. The present disclosure is not limited to the following embodiment, and various modifications can be made without departing from the gist of the present disclosure. Furthermore, the present disclosure includes any combination of components that can be combined, from among the components indicated in the embodiments and the modifications below. Furthermore, in each drawing, those denoted with the same reference numerals are the same or equivalent, and this is common in the entire specification. Note that, in each drawing, a relative dimensional relationship or a shape of each component may be different from an actual component. Furthermore, in each drawing, the X axis and the Z axis intersect with each other. An extending direction of the X axis is, for example, a vertical direction and may be a perpendicular direction. An extending direction of the Z axis is, for example, a horizontal direction. The Y axis intersects with each of the X axis and the Z axis, and an extending direction of the Y axis is, for example, the horizontal direction.

### First Embodiment

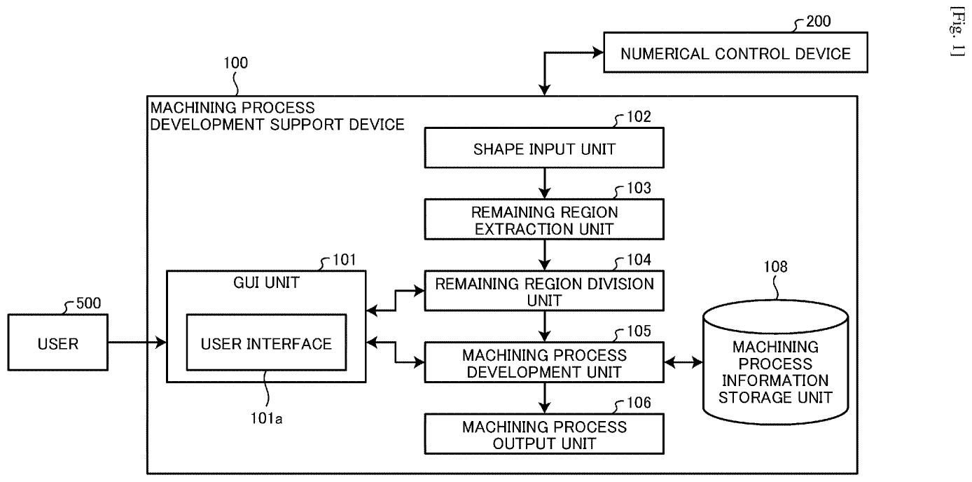

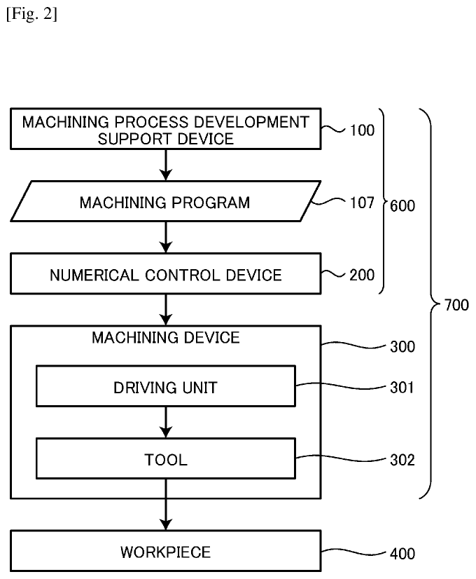

FIG. 1 is a block diagram illustrating a configuration of a machining process development support device according to a first embodiment. FIG. 2 is a block diagram illustrating a configuration of a machining process development support system and a machining system according to the first embodiment.

As illustrated in FIG. 1, a machining process development support device 100 includes a graphical user interface (GUI) unit 101, a shape input unit 102, a remaining region extraction unit 103, a remaining region division unit 104, a machining process development unit 105, a machining process output unit 106, and a machining process information storage unit 108. These modules will be described later.

As illustrated in FIGS. 1 and 2, the machining process development support device 100 is communicably connected to a numerical control device 200, as necessary. A machining program 107 generated by the machining process development support device 100 is input into the numerical control device 200, for example. As illustrated in FIG. 2, the machining process development support device 100 and the numerical control device 200 configure a machining process development support system 600 according to the first embodiment.

Furthermore, as illustrated in FIG. 2, the machining process development support device 100, the numerical control device 200, and a machining device 300 configure a machining system 700 according to the first embodiment.

The numerical control device 200 receives the machining program 107 transmitted from the machining process development support device 100 and executes the machining program 107 so as to generate a machining command. Furthermore, the numerical control device 200 generates a control signal indicating the generated machining command and outputs the control signal to the machining device 300. Note that the numerical control device 200 may be referred to as an NC device.

The machining device 300 includes a driving unit 301 and a tool 302. The tool 302 may be referred to as a machining tool. The machining device 300 receives the control signal from the numerical control device 200, drives the tool 302 via the driving unit 301 according to the control signal, and machines a workpiece 400. The workpiece 400 is an object to be machined by the machining device 300. The workpiece 400 is also called a material. Hereinafter, the shape of the workpiece 400, that is, an initial shape of the workpiece 400 before being machined is referred to as a blank shape. Furthermore, manufactural goods generated by machining the workpiece 400 by the machining device 300 are referred to as products, and the shape of the product is referred to as a product shape or a final product shape.

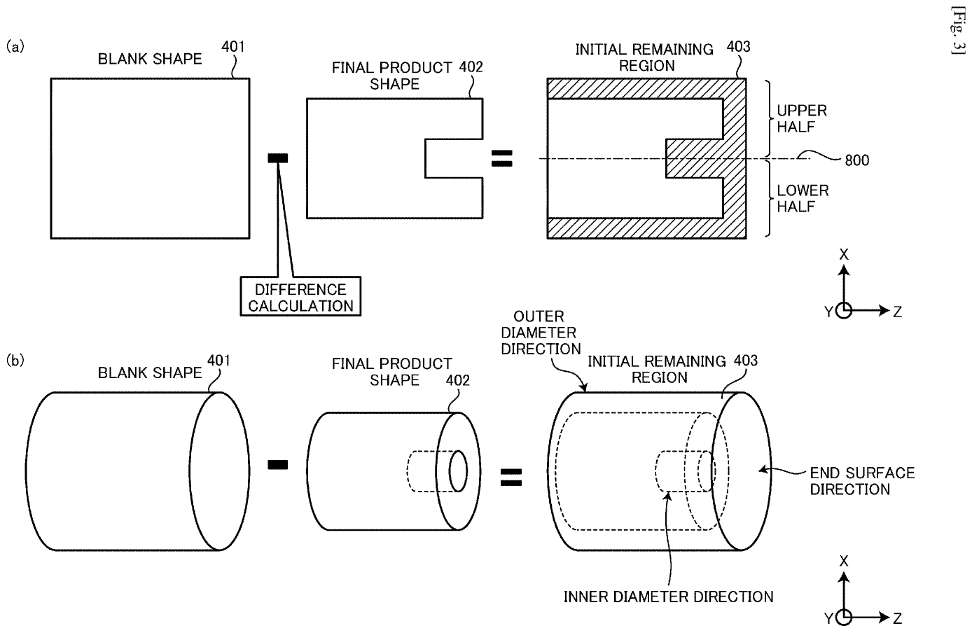

Hereinafter, each module of the machining process development support device 100 will be described with reference to FIGS. 1 and 3. FIG. 3 is a diagram illustrating an example of the blank shape, the final product shape, and an initial remaining region in the machining process development support device according to the first embodiment. Note that, in FIG. 3(a), a two-dimensional image displayed on a screen of a user interface 101a of the GUI unit 101 is illustrated. FIG. 3(a) illustrates a cross-sectional shape in a case of being cut along a virtual plane passing through a central axis 800 of the blank shape and the final product shape. The virtual plane is a plane parallel to the XZ plane. On the other hand, FIG. 3(b) is a perspective view illustrating the blank shape, the final product shape, and the shape of the initial remaining region.

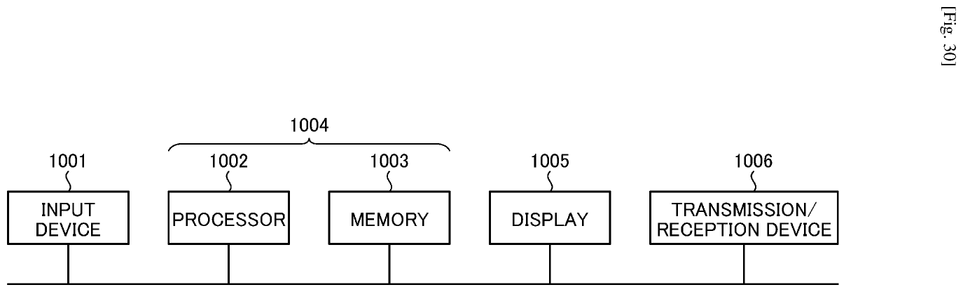

The GUI unit 101 illustrated in FIG. 1 includes the user interface 101a that receives instructions of a user 500. The user interface 101a includes a display screen and displays various types of data on the screen. The user interface 101a includes, for example, a keyboard, a mouse, a display, or a touch panel. In this way, the user interface 101a includes an input device 1001 (refer to FIG. 30) and a display 1005 (refer to FIG. 30).

The shape input unit 102 illustrated in FIG. 1 accepts input of shape data of a blank shape 401 and shape data of a final product shape 402. The shape data input into the shape input unit 102 is, for example, three-dimensional CAD data. The shape data is stored in a database in advance and is read by the shape input unit 102. Alternatively, the shape data may be directly input into the shape input unit 102, for example, using the GUI unit 101. In a case where the shape data is directly input, for example, the user 500 draws the shape data using the GUI unit 101.

The remaining region extraction unit 103 illustrated in FIG. 1 extracts an initial remaining region 403, based on the blank shape 401 and the final product shape 402 input through the shape input unit 102. The remaining region 403 indicates a region to be machined using the machining device 300, in the entire region of the blank shape 401. As illustrated in FIG. 3, the remaining region extraction unit 103 extracts the initial remaining region 403, by performing a difference calculation for subtracting the final product shape 402 from the blank shape 401. That is, the remaining region extraction unit 103 extracts the initial remaining region 403 by comparing the shape data of the blank shape 401 with the shape data of the final product shape 402. In the example in FIG. 3, the blank shape 401 has a cylindrical shape. Note that the blank shape 401 is not limited to the cylindrical shape and may be a polygonal prism shape. Furthermore, in the example in FIG. 3, the final product shape 402 has substantially a cylindrical shape, and a cylindrical hole is provided in one end surface. Furthermore, an outer diameter dimension of the final product shape 402 is smaller than an outer diameter dimension of the blank shape 401. Moreover, a length of the final product shape 402 in the Z direction is shorter than a length of the blank shape 401 in the Z direction. The Z direction is an extending direction of the central axis 800. Therefore, the initial remaining region 403 is a region indicated hatching in the rightmost diagram in FIG. 3(a). That is, for example, in order to form the final product shape 402 from the blank shape 401, three machining processes including a turning machining process for cutting the blank shape 401 in the outer diameter direction by a certain thickness, an end surface machining process for cutting one end of the blank shape 401, and a hole machining process for forming a hole in one end surface of the blank shape 401 are needed.

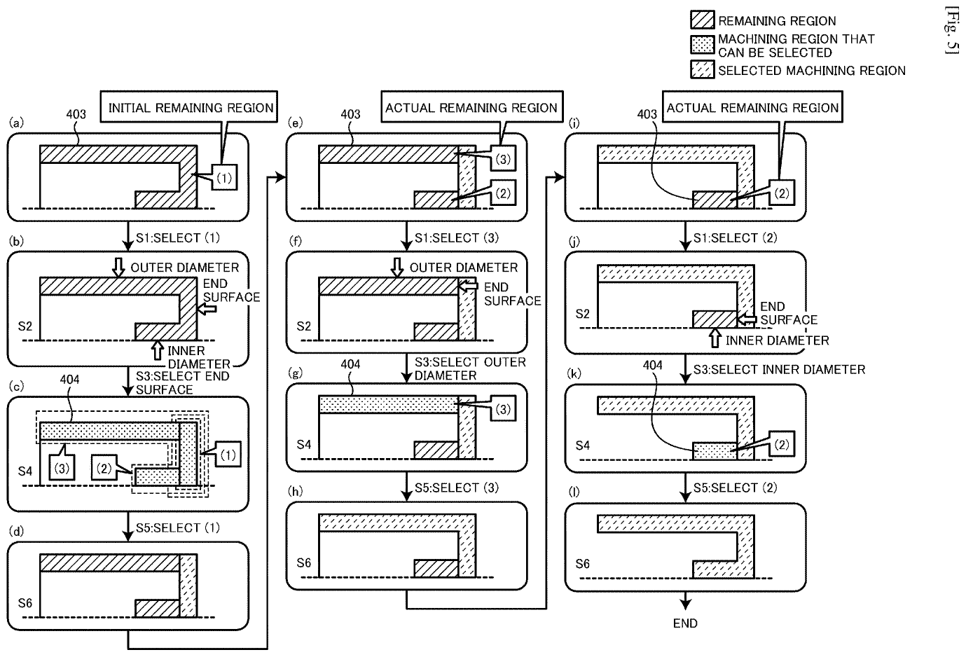

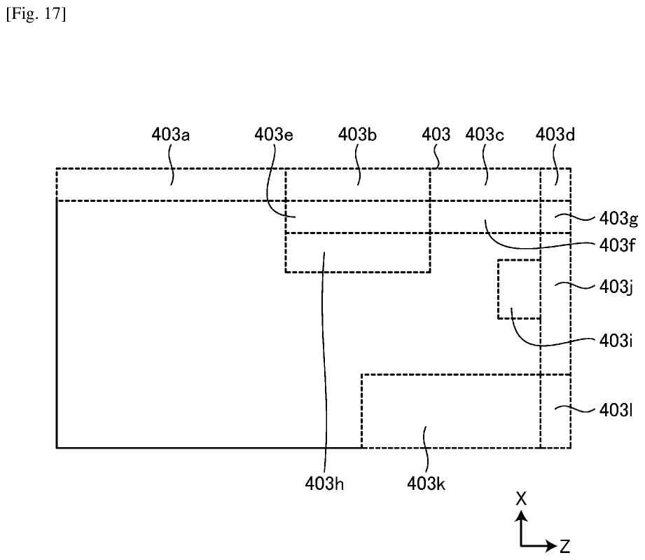

The remaining region division unit 104 illustrated in FIG. 1 divides the initial remaining region 403 extracted by the remaining region extraction unit 103 into a plurality of machining regions 404 (refer to FIG. 5). A method for dividing the remaining region 403 into the machining regions by the remaining region division unit 104 is, for example, as follows. First, the remaining region division unit 104 divides the initial remaining region 403 extracted by the remaining region extraction unit 103 into a plurality of sub-remaining regions (refer to 403a to 403l in FIG. 17). The sub-remaining region is formed by cutting the remaining region 403 along a virtual line parallel to the X axis and the Z axis. The remaining region division unit 104 combines one or more sub-remaining regions to form one machining region. The sub-remaining regions used for combination are adjacent to each other and continuous with each other. Note that as a method for dividing the remaining region 403 into the machining regions, another method may be used. The machining device 300 machines the workpiece 400 for each machining region. Note that the remaining region division unit 104 may present only one division pattern, in the division of the remaining region 403 into the machining region. However, two or more division patterns may be presented as candidates. In a case where the remaining region division unit 104 presents the two or more division patterns, the user 500 selects one division pattern from among these division patterns and inputs the selected division pattern into the GUI unit 101. The candidate of the division pattern includes one or more machining region candidates.

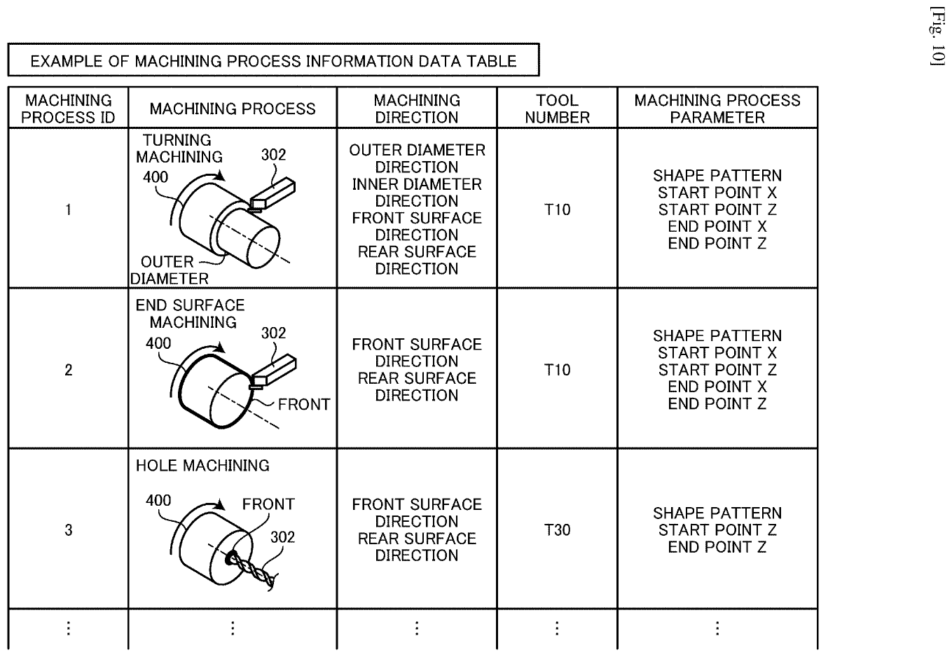

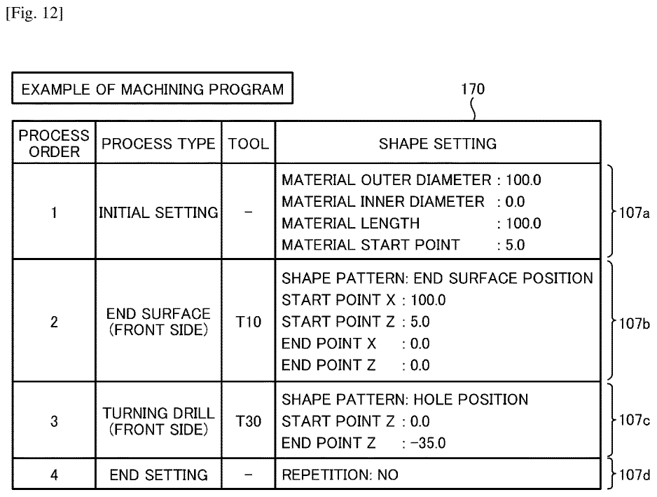

The machining process development unit 105 illustrated in FIG. 1 supports development of a machining process, based on shape information of the machining region 404 formed by the remaining region division unit 104. The shape information of the machining region 404 includes a shape pattern, the X coordinate value, the Z coordinate value, the Y coordinate value, or the like of the machining region 404. As illustrated in FIG. 12, the shape pattern is information indicating a position and a shape of the machining region 404, such as an end surface position or a hole position. Furthermore, the X coordinate value includes two coordinate values including a start point X where the machining region 404 starts and an end point X where the machining region 404 ends, on the X axis. The same applies to the Z coordinate value and the Y coordinate value. Note that the shape information of the machining region 404 does not need to include all the information described here and only need to include necessary information. Furthermore, the shape information of the machining region 404 may include another piece of information other than the information described here. A method for supporting development of a machining process by the machining process development unit 105 will be described later. The development of the machining process is to extract one or a plurality of machining processes that can process a machining region, from among a plurality of machining processes stored in a database in advance and to set a value of a machining process parameter for each machining process. The information stored in the database is referred to as machining process information below. The machining process information is stored in the machining process information storage unit 108 in advance. In this way, the machining process information includes the plurality of machining processes and the items of the machining process parameters required for each machining process. About the machining process information, refer to FIG. 10 to be described later.

The machining process output unit 106 illustrated in FIG. 1 outputs the machining process developed with the support of the machining process development unit 105 as the machining program 107. In a case where the machining process development support device 100 is connected to the numerical control device 200, the machining program 107 is output toward the numerical control device 200.

The machining process information storage unit 108 illustrated in FIG. 1 stores the machining process information in advance, as described above. The machining process information storage unit 108 includes, for example, a memory.

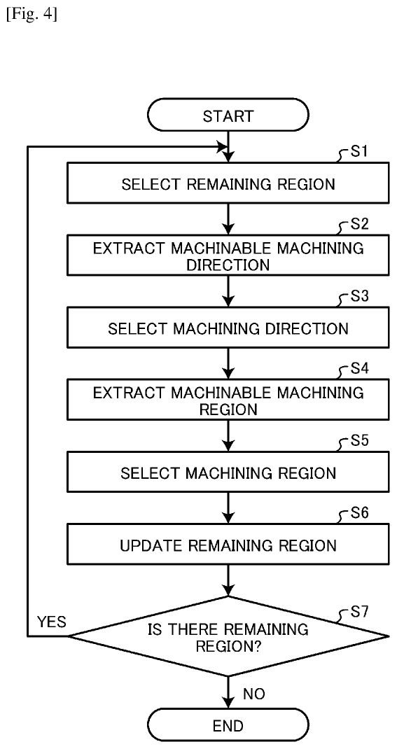

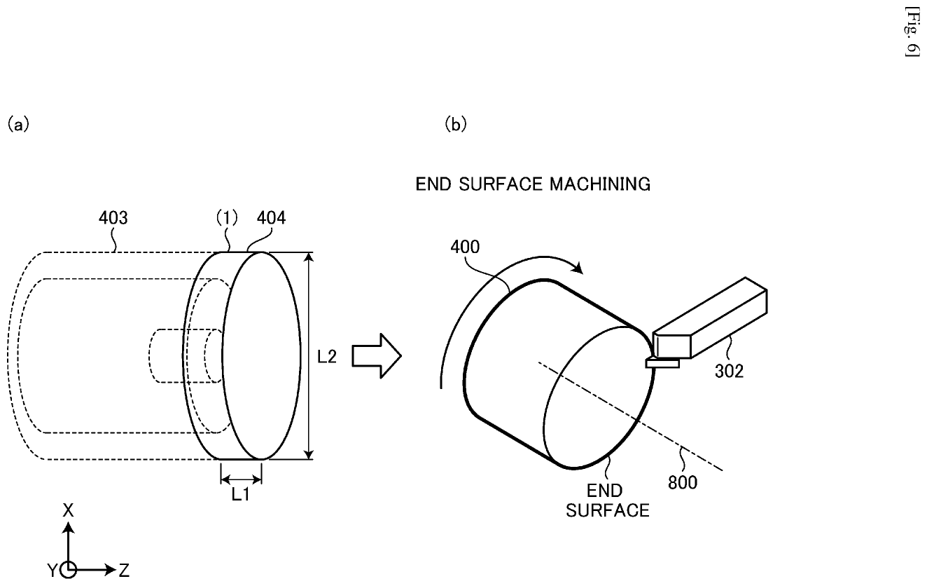

Next, the method for dividing the remaining region 403 into the machining regions 404 by the remaining region division unit 104 will be described with reference to FIGS. 4 to 8. FIG. 4 is a flowchart illustrating a procedure for dividing the remaining region by the remaining region division unit provided in the machining process development support device according to the first embodiment. FIG. 5 is a diagram illustrating an example of the procedure for dividing the remaining region by the remaining region division unit provided in the machining process development support device according to the first embodiment. In each of FIG. 5(a) to 5(l), only an upper half of the rightmost diagram in FIG. 3(a) is illustrated. FIGS. 6 to 8 are diagrams illustrating an example of a machining region and a machining process of the machining process development support device according to the first embodiment.

Processing for dividing the remaining region into the machining regions is processing for decomposing a remaining region into machining units in each of which continuous machining is performed with the same main shaft and the same tool. Therefore, the machining region formed through the division processing is a region where continuous machining work can be performed in the same machining direction and using the same tool. Also, the machining process development processing is processing for decomposing a flow of a series of machining works to generate a product by machining a material into machining units in which continuous machining is performed with the same main shaft and using the same tool. Note that the flow of the series of machining works includes, for example, turning machining, end surface machining, hole machining, groove machining, chamfering machining, copying machining, or the like.

As illustrated in FIG. 5(a), in step S1 in FIG. 4, the remaining region division unit 104 displays the remaining region 403 on the screen of the user interface 101a of the GUI unit 101. Here, as illustrated in FIG. 5(a), the initial remaining region 403 extracted by the remaining region extraction unit 103 is displayed on the screen. Note that, in the example in FIG. 5(a), a U-shaped portion indicated by hatching is the initial remaining region 403 displayed on the screen. At this stage, the remaining region 403 is not divided. Therefore, the remaining region 403 is one region indicated by a reference numeral (1). The user 500 selects and inputs the remaining region 403 indicated by the reference numeral (1), using the user interface 101a of the GUI unit 101. As a result, the remaining region 403 indicated by the reference numeral (1) is selected.

In step S2 in FIG. 4, as illustrated in FIG. 5(b), the remaining region division unit 104 extracts a machining direction in which the workpiece 400 can be machined, based on the blank shape 401 and the final product shape 402. In the example in FIG. 5(b), as the machinable machining direction, three machining directions including an outer diameter direction, an inner diameter direction, and an end surface direction are extracted. These machining directions are displayed on the screen of the user interface 101a of the GUI unit 101.

In step S3 in FIG. 4, as illustrated in FIG. 5(b), through selection input of the user 500, one machining direction is selected from among the plurality of machining directions extracted in step S2. Specifically, the user 500 selects one machining direction from among the plurality of machining directions extracted in step S2 and inputs the one machining direction, using the user interface 101a of the GUI unit 101. In the example in FIG. 5(b), the user 500 selects and inputs the end surface direction. As a result, the end surface direction is determined as the machining direction.

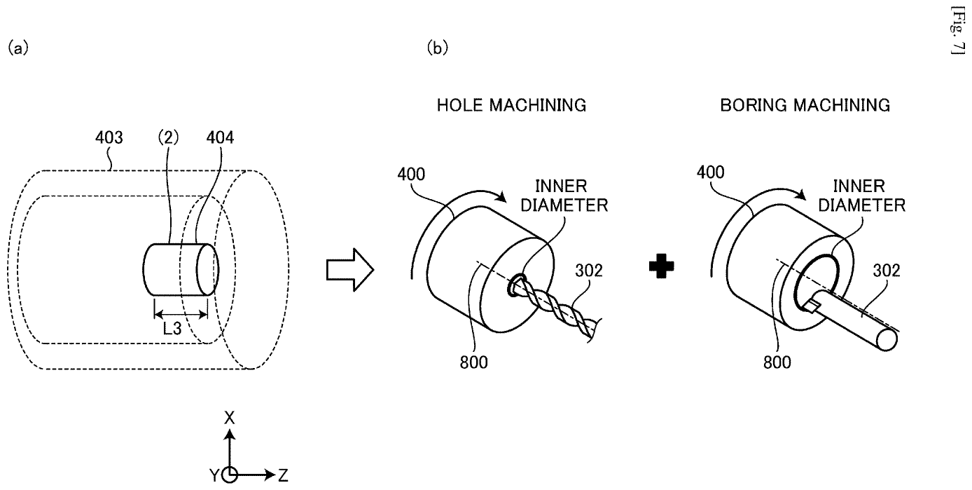

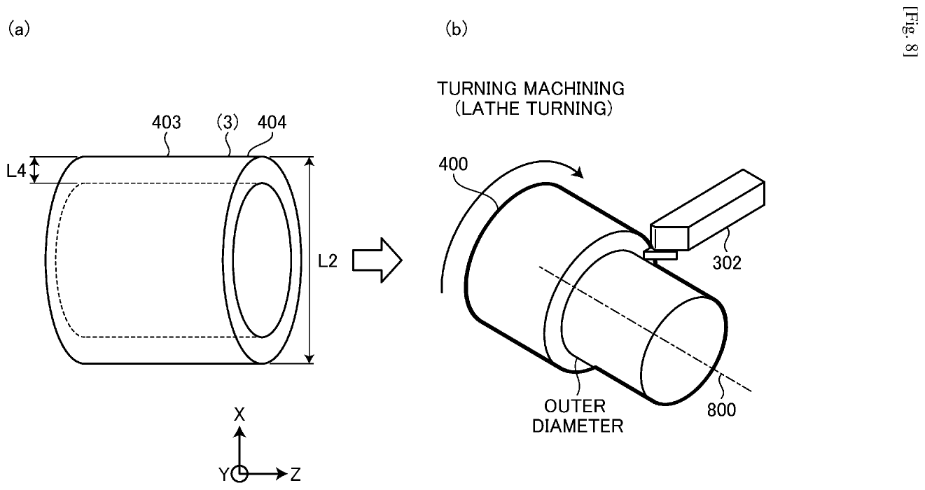

In step S4 in FIG. 4, as illustrated in FIG. 5(c), the remaining region division unit 104 extracts all the machining regions that can be machined from the end surface direction that is the selected machining direction. In the example in FIG. 5(c), three machining regions 404 indicated by reference numerals (1) to (3) are extracted. That is, in the example in FIG. 5(c), the remaining region 403 illustrated in FIG. 5(a) is divided into the three machining regions 404. The number of machining regions 404 generated through division is not limited to three and may be any number equal to or more than one. In the example in FIG. 5(c), the machining region 404 indicated by the reference numeral (1) is illustrated as a vertically long rectangle. However, actually, the machining region 404 has a disk-like shape as indicated by a solid line in FIG. 6(a). Furthermore, in the example in FIG. 5(c), the machining region 404 indicated by the reference numeral (2) is illustrated as a horizontally long rectangle. However, actually, the machining region 404 has a cylindrical shape as indicated by a solid line in FIG. 7(a). Furthermore, in the example in FIG. 5(c), the machining region 404 indicated by the reference numeral (3) is illustrated as a horizontally long rectangle. However, actually, the machining region 404 has a cylindrical shape as illustrated in FIG. 8(a). Note that the machining regions 404 illustrated in FIGS. 5 to 8 are merely example, and are not limited to these shapes and may have any shape.

In step S5 in FIG. 4, as illustrated in FIG. 5(c), through selection input of the user 500, one machining region is selected from among the plurality of machining regions extracted in step S4. Specifically, the user 500 selects one machining region from among the plurality of machining regions (1) to (3) extracted in step S4, using the user interface 101a of the GUI unit 101. In the example in FIG. 5(c), the user 500 selects and inputs the machining region 404 indicated by the reference numeral (1). As a result, the machining region 404 indicated by the reference numeral (1) is selected as a “first machining region”. For the selected “first machining region”, the machining process is developed by the machining process development unit 105.

In step S6 in FIG. 4, as illustrated in FIG. 5(d), the remaining region division unit 104 updates the remaining region 403 to the latest one, using a shape of the first machining region of which the machining process is developed by the machining process development unit 105 and the shape of the initial remaining region 403. In the example in FIG. 5(d), the machining regions 404 other than the machining region 404 indicated by the reference numeral (1) selected by the user 500, that is, the two machining regions 404 indicated by the reference numerals (2) and (3) are new remaining regions 403. Hereinafter, the new remaining region is referred to as an actual remaining region. As described above, the remaining region division unit 104 updates the remaining region 403 each time when one machining region 404 is selected.

In step S7 in FIG. 4, the remaining region division unit 104 determines whether or not there is an unselected remaining region 403. That is, the remaining region division unit 104 determines whether or not there is a machining region 404 of which a machining process is not developed by the machining process development unit 105. As a result of the determination in step S7, in a case where there is the remaining region 403, the remaining region division unit 104 returns to the processing in step S1. On the other hand, as a result of the determination in step S7, in a case where there is no remaining region 403, the remaining region division unit 104 ends the processing of the flow in FIG. 4. In the example in FIG. 5(d), the two machining regions 404 indicated by the reference numerals (2) and (3) remain as the remaining regions 403. Therefore, the remaining region division unit 104 returns to the processing in step S1.

In FIGS. 5(e) to 5(h), the processing in steps S1 to S7 in FIG. 4 is executed again. In FIG. 5(e), as an actual remaining region 403, the two machining regions 404 indicated by the reference numerals (2) and (3) are displayed on the screen. In step S1, when the user 500 selects and inputs the machining region 404 indicated by the reference numeral (3), in step S2, the outer diameter direction and the end surface direction are extracted as machinable machining directions as illustrated in FIG. 5(f). In response to the extraction, when the user 500 selects and inputs the outer diameter direction in step S3, the machining region 404 indicated by the reference numeral (3) is extracted in step S4 as a “second machining region” and as the machinable machining region 404, as illustrated in FIG. 5(g). In response to the extraction, when the user 500 selects and inputs the machining region 404 indicated by the reference numeral (3) in step S5, the remaining region 403 is updated in step S6. In the example in FIG. 5(h), one machining region 404 indicated by the reference numeral (2) is a new remaining region 403. Therefore, the remaining region division unit 104 determines in step S7 that there is the remaining region 403, and returns to the processing in step S1.

In FIGS. 5(i) to 5(l), the processing in steps S1 to S7 in FIG. 4 is executed again. In FIG. 5(i), as the actual remaining region 403, one machining region 404 indicated by the reference numeral (2) is displayed on the screen. When the user 500 selects and inputs the machining region 404 indicated by the reference numeral (2) in step S1, the inner diameter direction and the end surface direction are extracted in step S2 as the machinable machining directions as illustrated in FIG. 5(j). In response to the extraction, when the user 500 selects and inputs the inner diameter direction in step S3, the machining region 404 indicated by the reference numeral (2) is extracted in step S4 as a “third machining region” and as the machinable machining region 404, as illustrated in FIG. 5(k). In response to the extraction, when the user 500 selects and inputs the machining region 404 indicated by the reference numeral (2) in step S5, the remaining region 403 is updated in step S6. In the example in FIG. 5(l), since the machining processes for all the machining regions have been developed, the remaining region division unit 104 determines in step S7 that there is no remaining region 403 and ends the processing of the flow in FIG. 4.

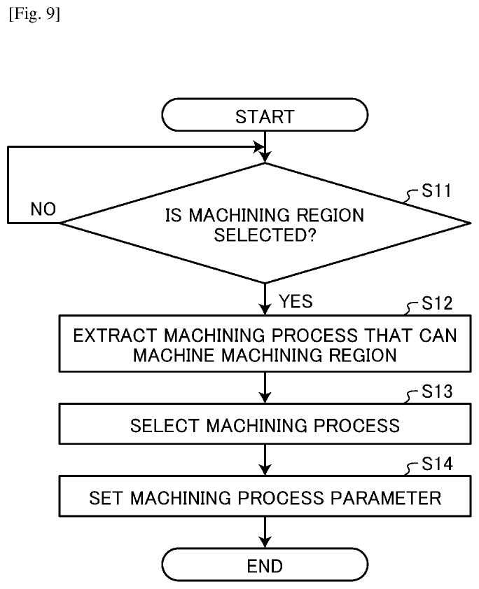

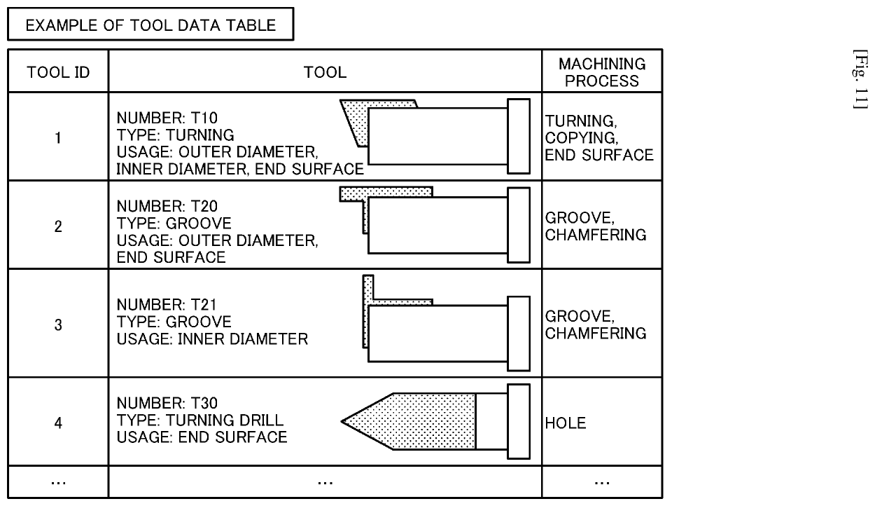

Next, the method for supporting the development of the machining process by the machining process development unit 105 will be described with reference to FIGS. 9 to 12 and FIGS. 6 to 8. FIG. 9 is a flowchart illustrating a procedure of development support processing of a machining process by the machining process development unit provided in the machining process development support device according to the first embodiment. FIG. 10 is a diagram illustrating an example of a data table of machining process information of the machining process development support device according to the first embodiment. FIG. 11 is a diagram illustrating an example of a tool data table of the machining process development support device according to the first embodiment. FIG. 12 is a diagram illustrating an example of a machining program generated by the machining process development support device according to the first embodiment.

The machining process development unit 105 supports the development of the machining process, based on the shape information of the machining region formed by the remaining region division unit 104. In the machining process development processing, first, one or a plurality of machining processes that can machine a machining region is extracted from among the plurality of machining processes stored in the machining process information storage unit 108 in advance, based on the shape data of the machining region, for each machining region. At this time, for each machining region, the machining process is extracted so as to continuously perform machining in the same machining direction and with the same tool. Then, in the machining process development processing, the value of the machining process parameter is set for each machining process, based on the machining process information stored in the machining process information storage unit 108 in advance. The machining process information is stored in the machining process information storage unit 108 illustrated in FIG. 1, in advance. The machining process information includes the plurality of machining processes and items of the machining process parameters required for each machining process. The items of the machining process parameters include a shape pattern of a machining region, a position of a start point and a position of an end point in the X direction, a position of a start point and a position of an end point in the Z direction, or the like, as illustrated in FIG. 10.

Although the machining process development unit 105 executes the machining process development processing for each machining region according to the flow in FIG. 9, the machining process information is stored in the machining process information storage unit 108 illustrated in FIG. 1 in advance, before the processing in FIG. 9 is executed. That is, the machining process development unit 105 stores the machining process information including the plurality of machining processes and the items of the machining process parameters required for each machining process in the machining process information storage unit 108 in advance.

As illustrated in FIG. 9, in step S11, the machining process development unit 105 determines whether or not the machining region is selected by the remaining region division unit 104 in step S5 in the flow of FIG. 4. That is, the machining process development unit 105 determines whether or not a signal indicating the selected machining region is input from the remaining region division unit 104.

In a case where it is determined that the signal indicating the machining region is input in the determination in step S11, the procedure proceeds to step S12, and otherwise, the processing in step S11 is repeated at a preset cycle.

In step S12, the machining process development unit 105 extracts one or a plurality of machining processes that can machine the machining region, based on the shape information of the machining region, from among the plurality of machining processes stored in the machining process information storage unit 108 in advance, for the machining region input in step S11. FIG. 10 is a diagram illustrating an example of the data table of the machining process information stored in the machining process information storage unit 108 in advance. In the example in FIG. 10, a plurality of types of machining processes is stored in the database of the machining process information. Furthermore, the database of the machining process information includes data of a machining process ID, a machining process, a machining direction, a tool number of the tool 302 used for the machining process, items of machining process parameters, or the like, for each machining process. Furthermore, FIG. 11 is a diagram illustrating an example of the tool data table stored in the machining process information storage unit 108 in advance. In the example in FIG. 11, data of a plurality of tools is stored in the tool data table. The tool data table is stored in the machining process information storage unit 108 illustrated in FIG. 1 in advance. The tool data table includes data of a tool ID, a tool number, a type of machining, a usage, or the like, for each tool. In this way, in step S12, the machining process development unit 105 extracts one or the plurality of machining processes that can machine the machining region, using the machining process data table and the tool data table, based on the shape of the machining region.

Here, a specific example will be described. In a case where the machining region 404 has a disk-like shape as illustrated in FIG. 6(a), the machining process development unit 105 extracts the machining process that can machine the machining region 404, based on the shape information of the machining region 404, from the database of the machining process information. In a case of FIG. 6(a), the machining region 404 can be machined through the end surface machining. Therefore, the machining process development unit 105 extracts the end surface machining, as illustrated in FIG. 6(b), as the machining process that can machine the machining region 404. The end surface machining is a process for cutting one end surface of the workpiece 400 only by a length L1 and adjusting the cut surface as a planar shape.

Furthermore, in a case where the machining region 404 has a cylindrical hole-like shape as illustrated in FIG. 7(a), the machining process development unit 105 extracts the machining process that can machine the machining region 404, based on the shape information of the machining region 404, from the database of the machining process information. In a case of FIG. 7(a), the machining region 404 can be machined through the hole machining. Therefore, the machining process development unit 105 extracts the hole machining, as illustrated in FIG. 7(b), as the machining process that can machine the machining region 404. Alternatively, the machining process development unit 105 may extract two machining processes including the hole machining and the boring machining as illustrated in FIG. 7(b), as the machining process that can machine the machining region 404. The hole machining is machining for forming a hole using a tool such as a drill. The boring machining is machining for expanding the hole formed through the hole machining. The boring machining is used for machining of a hole with a large inner diameter or inner surface finishing of a hole.

Furthermore, in a case where the machining region 404 has a cylindrical shape as illustrated in FIG. 8(a), the machining process development unit 105 extracts the machining process that can machine the machining region 404, based on the shape of the machining region 404, from the database of the machining process information. In a case of FIG. 8(a), since the machining region 404 can be machined through the turning machining, the machining process development unit 105 extracts the turning machining, as illustrated in FIG. 8(b), as the machining process that can machine the machining region 404. The turning machining is machining for reducing the outer diameter of the blank shape 401 by cutting the outer periphery of the blank shape 401.

In step S13, the user 500 selects one machining process from among the one or plurality of machining processes extracted by the machining process development unit 105 and inputs the machining process into the machining process development unit 105 via the GUI unit 101.

In step S14, the machining process parameter is set to the machining region selected in step S13, based on the machining process information and the shape information of the machining region stored in the machining process information storage unit 108.

Here, setting of the machining process parameter will be described using a specific example. In a case where the machining region 404 has a disk-like shape as illustrated in FIG. 6(a), as described above, the end surface machining is extracted as the machining process that can machine the machining region 404. At this time, the machining process parameters include an “end surface position” as the shape pattern, a start point X, a start point Z, an end point X, an end point Z, a length L1 in the Z direction, a length L2 of the outer diameter of the blank shape 401, or the like. Since these values of the machining process parameters can be acquired by the machining process development unit 105 from the shape information of the machining region 404, it is not necessary for the user 500 to input these values.

Furthermore, in a case where the machining region 404 has a cylindrical hole-like shape as illustrated in FIG. 7(a), as described above, the hole machining or the hole machining and the boring machining are extracted as the machining process that can machine the machining region 404. At this time, the machining process parameters include a “hole position” as the shape pattern, a start point Z, an end point Z, a length L3 in the Z direction, or the like. Since these values of the machining process parameters can be acquired by the machining process development unit 105 from the shape information of the machining region 404, it is not necessary for the user 500 to input these values.

Furthermore, in a case where the machining region 404 has a cylindrical shape as illustrated in FIG. 8(a), as described above, the turning machining is extracted as the machining process that can machine the machining region 404. At this time, the machining process parameters include an “outer diameter position” as the shape pattern, a start point X, a start point Z, an end point X, an end point Z, an outer diameter length L2 of the blank shape 401, a length L4 in a diameter direction that is a thickness to be cut, or the like. Since these values of the machining process parameters can be obtained by the machining process development unit 105 from the shape information of the machining region, it is not necessary for the user 500 to input these values.

The processing of the flow in FIG. 9 is executed by the machining process development unit 105 each time when the machining region 404 is selected in step S5 in FIG. 4. Then, the machining process development unit 105 outputs the machining process on which the machining process development processing has been completed to the machining process output unit 106 in order or collectively for each product.

The machining process output unit 106 outputs the machining process developed with the support of the machining process development unit 105 as the machining program 107. In FIG. 12, an example of the machining program is illustrated. As illustrated in FIG. 12, the machining program 107 includes information of a process order indicating order of processing of a machining process, a process type, a tool, shape setting, or the like. In the example in FIG. 12, an example of the machining program 107 used to perform machining from the end surface direction is illustrated. In the example in FIG. 12, the machining program 107 includes an initial setting machining program 107a, a machining program 107b for end surface machining (refer to FIG. 6(b)), a machining program 107c for hole machining (refer to FIG. 7(b)), and an end setting machining program 107d. These four machining programs, that is, the machining processes can be executed from the same direction, that is, the end surface direction. However, since a machining region 404 to be machined is different between the machining program 107b for end surface machining and the machining program 107c for hole machining, after the machining program 107b is executed, the tool 302 is changed, and the machining program 107c is executed.

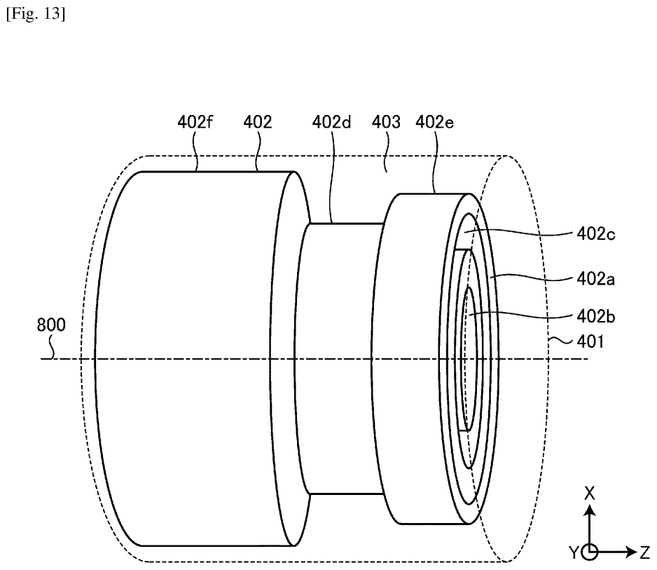

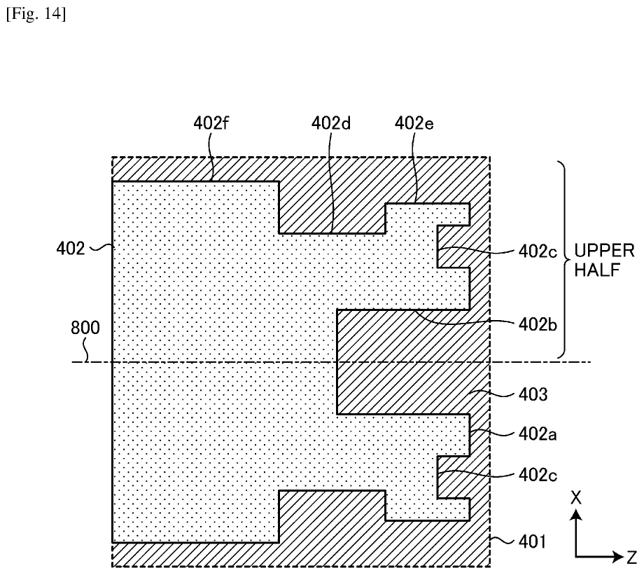

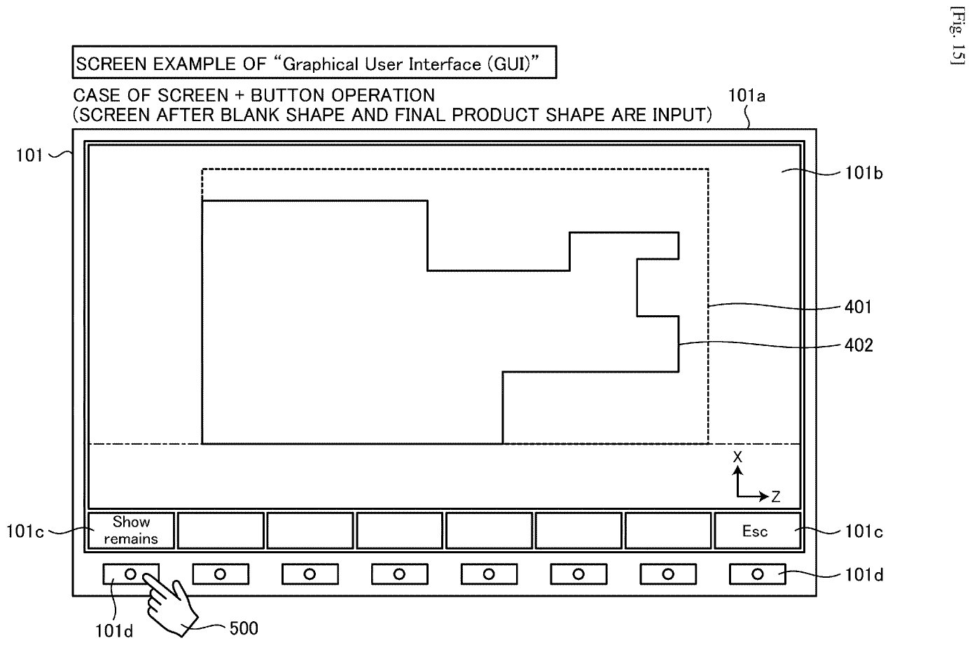

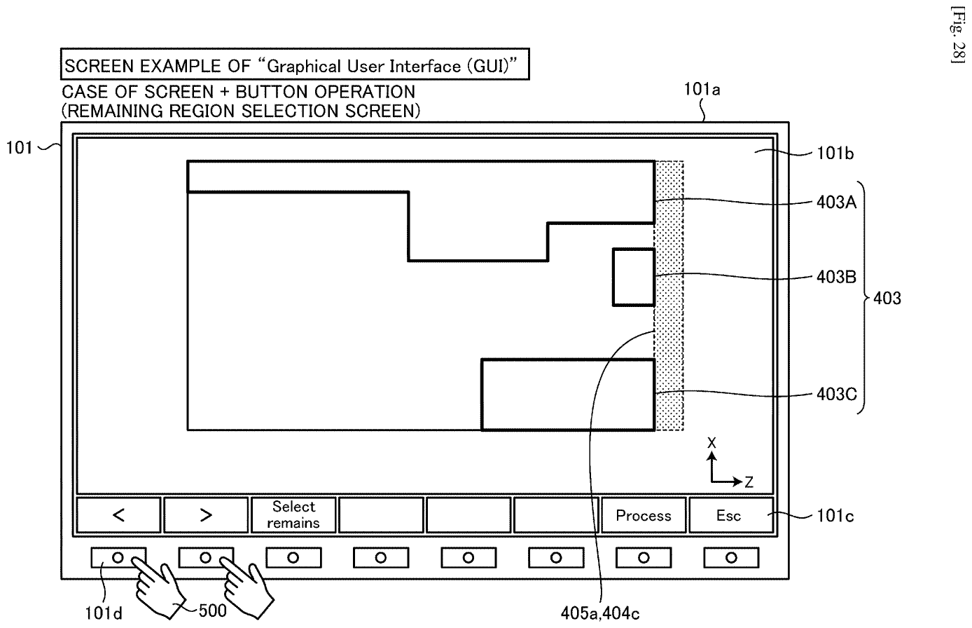

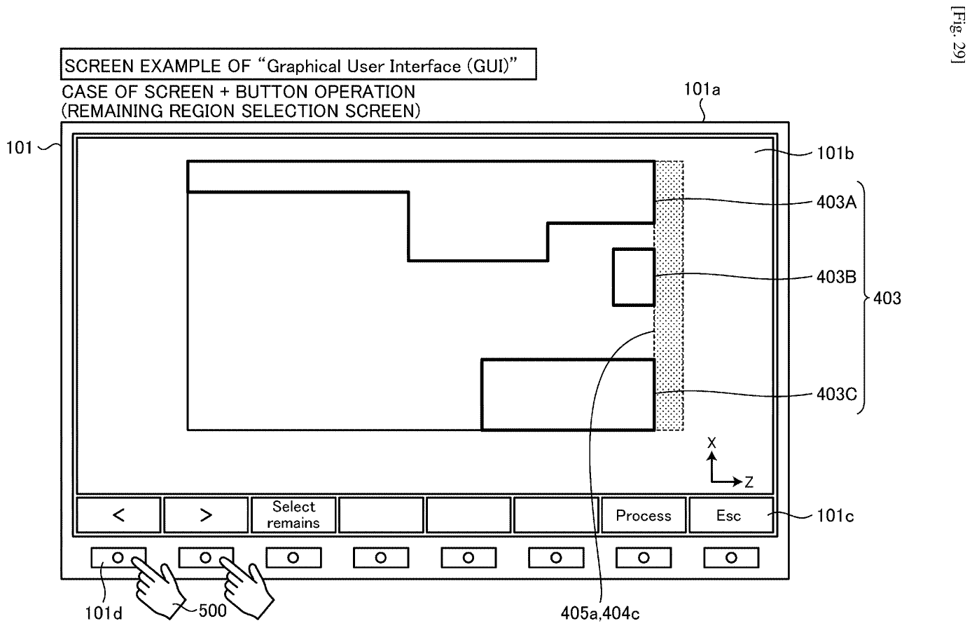

Next, the GUI unit 101 will be described with reference to FIGS. 13 to 29. FIG. 13 is a perspective view illustrating an example of the blank shape and the final product shape in the machining process development support device according to the first embodiment. FIG. 14 is a cross-sectional view illustrating an example of the blank shape and the final product shape in the machining process development support device according to the first embodiment. In FIG. 14, a cross section in a case of being cut along a virtual plane passing through the central axis 800 of the blank shape 401 and the final product shape 402 is illustrated. FIGS. 15 and 16 and FIGS. 18 to 29 are front views illustrating an example of the display screen of the user interface of the GUI unit of the machining process development support device according to the first embodiment. FIG. 17 is a diagram illustrating an example in which an initial remaining region in the machining process development support device according to the first embodiment is divided into a plurality of sub-remaining regions.

Here, as illustrated in FIGS. 13 and 14, as the blank shape 401, a shape of a metal cylindrical bar-like shaped material is exemplified. Furthermore, the final product shape 402 includes one cylindrical hole 402b provided in a center portion of one end surface portion 402a and a groove 402c arranged on a radially outer side of the hole 402b. The groove 402c is formed over the entire circumference in the circumferential direction. Therefore, the groove 402c has a donut-like shape as viewed from the side of the end surface portion 402a. The depth of the groove 402c is shallower than the hole 402b as illustrated in FIG. 14. Furthermore, the groove 402c is arranged at an interval with respect to the hole 402b on the radially outer side. Therefore, a flat portion having a donut-like shape is provided between the hole 402b and the groove 402c, and the hole 402b and the groove 402c do not communicate with each other. Moreover, the final product shape 402 has a constricted portion 402d in the middle in the Z direction. An outer diameter of the constricted portion 402d is shorter than other portions. A first end portion 402e adjacent in the Z direction to the constricted portion 402d has a disk-like shape. An end surface of the first end portion 402e is the end surface portion 402a described above. Furthermore, the first end portion 402e has a larger outer diameter than the constricted portion 402d. A second end portion 402f is arranged on the opposite side of the first end portion 402e with respect to the constricted portion 402d in the Z direction and is adjacent to the constricted portion 402d. The second end portion 402f has a disk-like shape. The end surface of the second end portion 402f is flat. Furthermore, the second end portion 402f has a larger outer diameter than the first end portion 402e. The length of the second end portion 402f in the Z direction is longer than those of the constricted portion 402d and the first end portion 402e.

FIGS. 15 to 29 illustrate a cross section in a case of being cut along the virtual plane passing through the central axis 800 of the blank shape 401 and the final product shape 402. However, only an upper half illustrated in FIG. 14 of the cross section is illustrated.

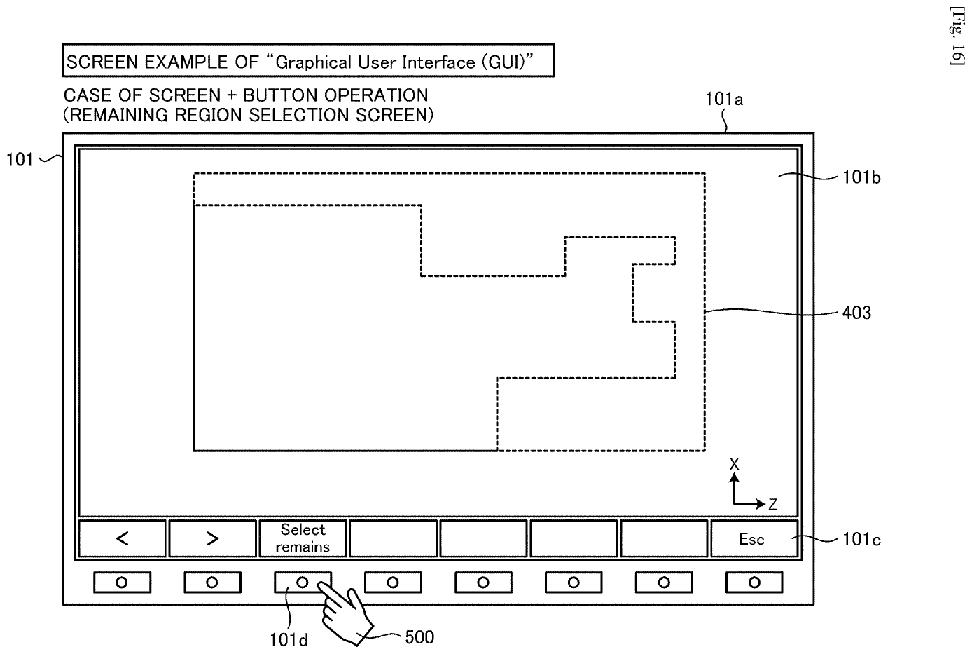

As illustrated in FIG. 15, first, the GUI unit 101 displays the blank shape 401 and the final product shape 402 on a main display 101b of the user interface 101a. In FIG. 15, a broken line indicates the blank shape 401, and a solid line indicates the final product shape 402. On a lower end portion of the main display 101b, a plurality of buttons 101d is provided, as illustrated in FIG. 15. In a case where the user interface 101a includes a touch panel, the button 101d includes a virtual button that is electronically displayed on the main display 101b. On the other hand, in a case where the user interface 101a includes a display such as a liquid crystal display, the button 101d includes a hard switch provided on a frame or a main body of the main display 101b. Above each button 101d, an operation explanation presentation portion 101c where an operation explanation of each button 101d is displayed is provided. In the screen in FIG. 15, when the user 500 operates the button 101d corresponding to the operation explanation presentation portion 101c displayed as “Show remains (display remaining region)”, the screen of the main display 101b is switched to a screen illustrated in FIG. 16.

In FIG. 16, the GUI unit 101 displays the initial remaining region 403 obtained through calculation by the remaining region extraction unit 103 illustrated in FIG. 1, on the main display 101b of the user interface 101a. In FIG. 16, a broken line indicates the initial remaining region 403. In a case of FIG. 16, the number of initial remaining regions is one. However, the number of initial remaining regions is not limited.

The initial remaining region 403 is divided into the plurality of sub-remaining regions 403a to 403l, as illustrated in FIG. 17, by the remaining region division unit 104 illustrated in FIG. 1. A method for forming the sub-remaining regions 403a to 403l will be described below. The remaining region 403 illustrated in FIG. 16 is divided by a virtual line parallel to the X axis and a virtual line parallel to the Z axis. These virtual lines pass through at least one of folding points where the broken line forming the remaining region 403 is folded. In the example in FIG. 17, the initial remaining region 403 is divided into the 12 sub-remaining regions 403a to 403l.

The remaining region division unit 104 generates one machining region 404 by combining one or more sub-remaining regions 403a to 403l. A condition of the combination of the sub-remaining regions 403a to 403l included in the machining region 404 is that the sub-remaining regions are continuous with each other. However, as long as the condition is satisfied, any combination may be used. Note that, each of the combinations is a candidate of a division pattern proposed by the remaining region division unit 104. Note that the processing for generating the machining region 404 by the remaining region division unit 104 is not limited to this method. That is, the method for generating the machining region 404 by dividing the remaining region 403 into the plurality of sub-remaining regions and combining the sub-remaining regions as illustrated in FIG. 17 is merely an example. The remaining region division unit 104 may generate the machining region 404 using another method.

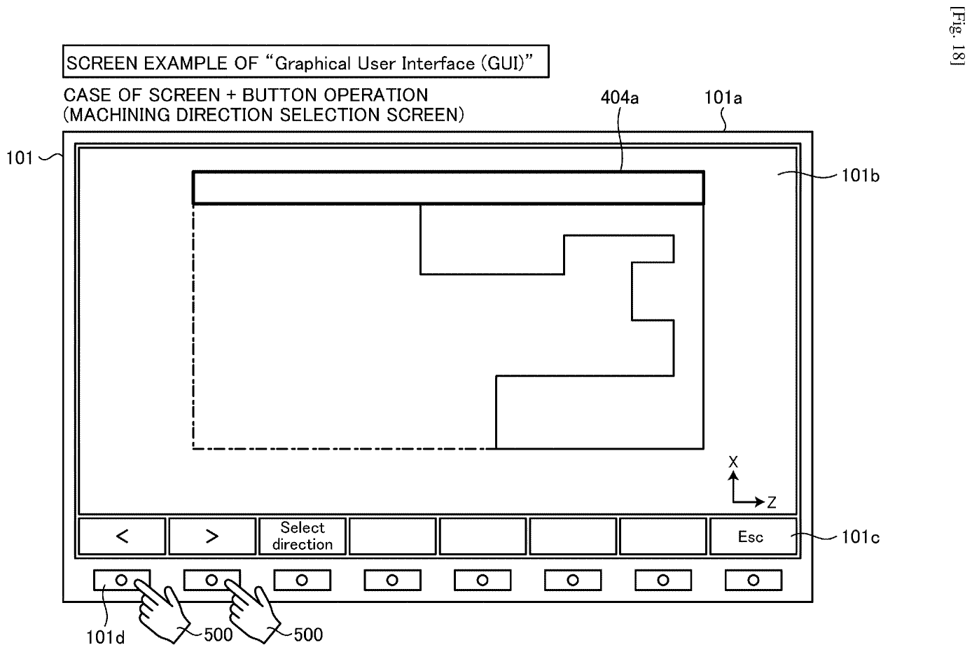

When the user 500 operates the button 101d corresponding to the operation explanation presentation portion 101c displayed as “Select remains (select remaining region)” in the screen in FIG. 16, the screen on the main display 101b is switched to the screen illustrated in FIG. 18.

FIGS. 18 to 20 are screen examples used to select the machining direction by the user 500. Processing on the screens illustrated in FIGS. 18 to 20 is the processing in step S2 in the flow of FIG. 4.

In the example of the screen in FIG. 18, as the machining direction in which the remaining region 403 can be machined, an outer diameter direction with a default value is indicated. The GUI unit 101 displays a machining region 404a representing the outer diameter direction, generated by the remaining region division unit 104, on the main display 101b of the user interface 101a. In FIG. 18, a machining region 404 indicated by a thick solid line, among the machining regions 404, is the machining region 404a displayed as the machining region representing the outer diameter direction. The machining region 404a is the machining region 404 configured by combining the sub-remaining regions 403a to 403d in FIG. 17. Note that, in FIG. 18, as an initial machining direction, the outer diameter direction is set as a default value. However, the initial machining direction is not limited to this case.

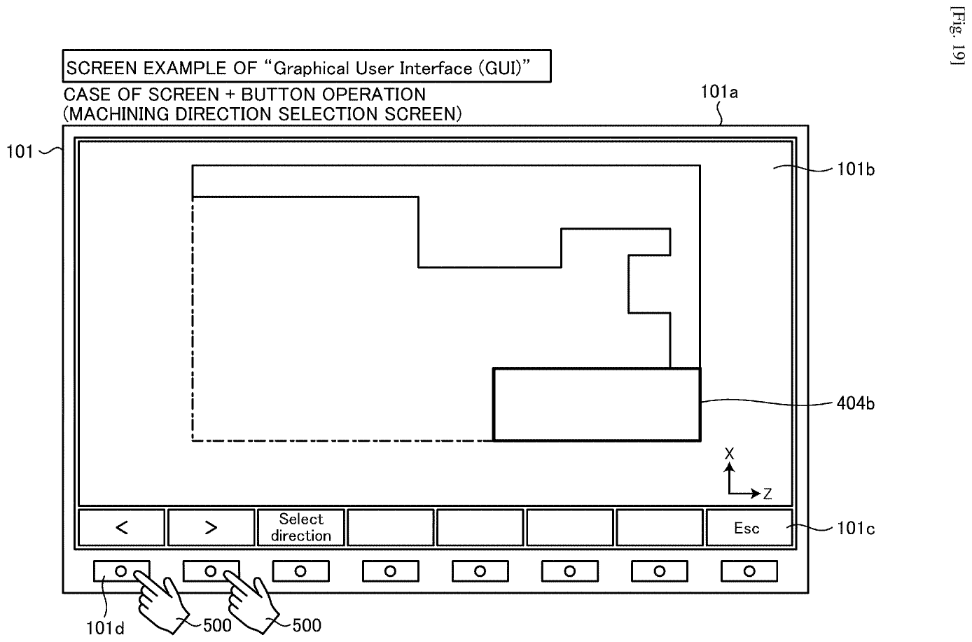

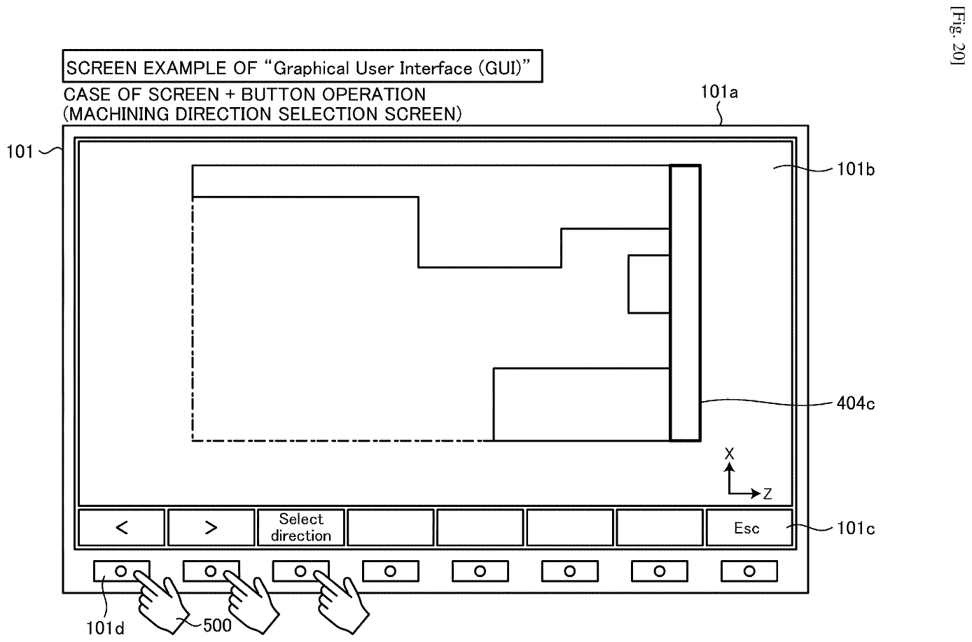

When the user 500 operates the button 101d corresponding to the operation explanation presentation portion 101c displayed as “>” in the screen in FIG. 18, the screen on the main display 101b is switched to the screen illustrated in FIG. 19. On the other hand, when the user 500 operates the button 101d corresponding to the operation explanation presentation portion 101c displayed as “<” in the screen in FIG. 18, the screen on the main display 101b is switched to the screen illustrated in FIG. 20.

The screen example in FIG. 19 will be described. The user 500 operates the button 101d corresponding to the operation explanation presentation portion 101c displayed as “>” in the screen in FIG. 18 so that the remaining region division unit 104 determines that the inner diameter direction is selected as the machining direction. Then, the remaining region division unit 104 generates one machining region 404a as the machining region representing the inner diameter direction. As illustrated in FIG. 19, the GUI unit 101 displays a machining region 404b generated by the remaining region division unit 104, on the main display 101b of the user interface 101a. In FIG. 19, a machining region 404 indicated by a thick solid line is the machining region 404b displayed as the machining region that can be machined in the inner diameter direction. The machining region 404b is the machining region 404 configured by combining the sub-remaining region 403k and the sub-remaining region 403l in FIG. 17.

The screen example in FIG. 20 will be described. The user 500 operates the button 101d corresponding to the operation explanation presentation portion 101c displayed as “<” in the screen in FIG. 18 so that the remaining region division unit 104 determines that the end surface direction is selected as the machining direction. Then, the remaining region division unit 104 generates one machining region 404c as the machining region representing the end surface direction. As illustrated in FIG. 20, the GUI unit 101 displays the machining region 404c generated by the remaining region division unit 104, on the main display 101b of the user interface 101a. In FIG. 20, a machining region 404 indicated by a thick solid line is the machining region 404c displayed as the machining region that can be machined in the inner diameter direction. The machining region 404c is the machining region 404 configured by combining the sub-remaining regions 403d, 403g, 403j, and 403l in FIG. 17.

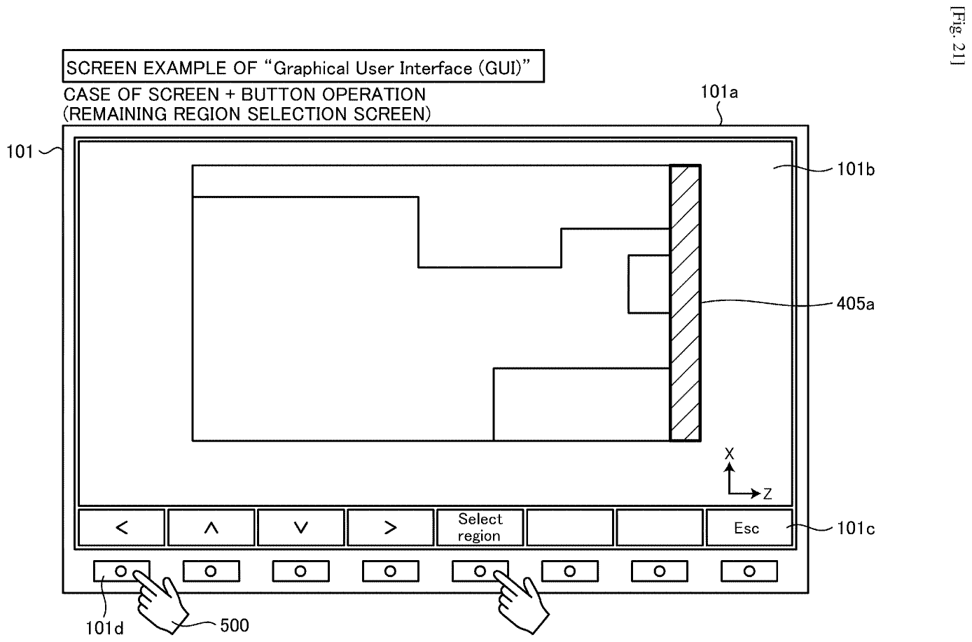

When the user 500 operates the button 101d corresponding to the operation explanation presentation portion 101c displayed as “>” in the screen in FIG. 20, the screen on the main display 101b is switched to the screen indicating the “outer diameter direction” illustrated in FIG. 18. On the other hand, when the user 500 operates the button 101d corresponding to the operation explanation presentation portion 101c displayed as “<” in the screen in FIG. 20, the screen on the main display 101b is switched to the screen of the “inner diameter direction” illustrated in FIG. 19. Furthermore, when the user 500 operates the button 101d corresponding to the operation explanation presentation portion 101c displayed as “Select direction (select machining direction)”, the “end surface direction” is determined as the machining direction, and the screen on the main display 101b is switched to the screen illustrated in FIG. 21. The determination of the machining direction is the processing in step S3 in the flow of FIG. 4.

FIGS. 21 to 26 are screen examples used to select the machining region by the user 500. Processing on the screens illustrated in FIGS. 21 to 26 is the processing in step S4 in the flow of FIG. 4. FIGS. 21 to 26 indicate respective candidates of the division pattern for the user 500 to select as the machining region 404.

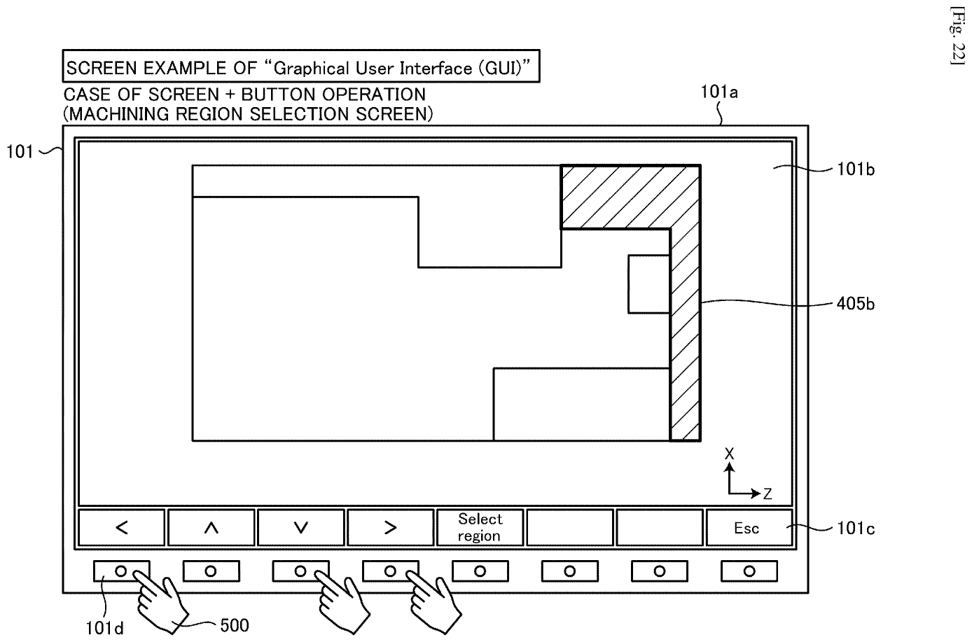

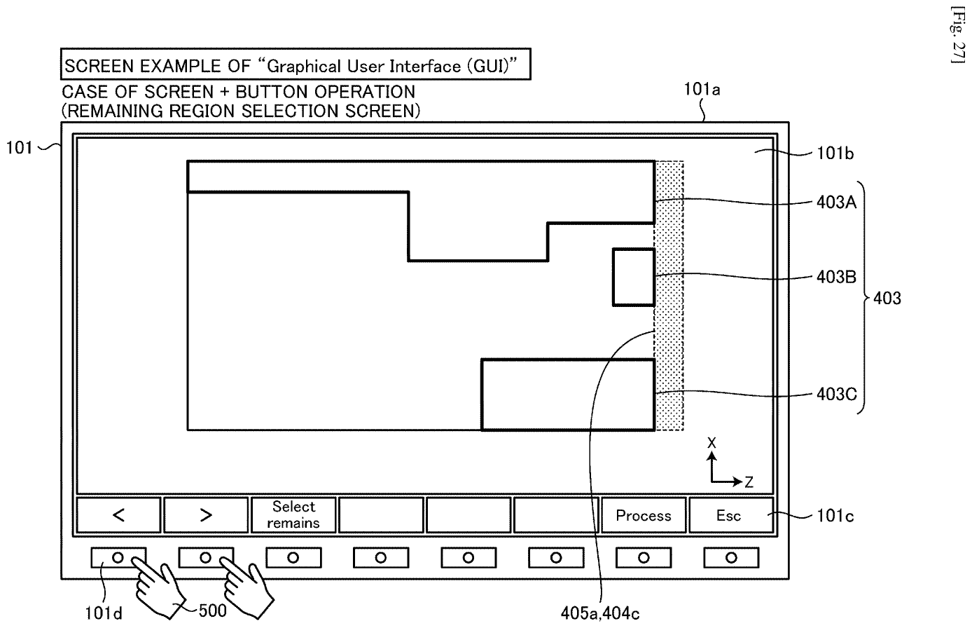

In the screen in FIG. 21, as a “first candidate” of the machining region 404, a machining region candidate 405a is displayed. The machining region candidate 405a is the machining region 404 configured by combining the sub-remaining regions 403d, 403g, 403j, and 403l in FIG. 17. When the user 500 operates the button 101d corresponding to the operation explanation presentation portion 101c displayed as “<” in the screen in FIG. 21, the screen on the main display 101b is switched to a screen indicating a “second candidate” illustrated in FIG. 22. Furthermore, when the user 500 operates the button 101d corresponding to the operation explanation presentation portion 101c displayed as “Select region (select machining region)”, the “first candidate” is determined as the machining region, and the screen on the main display 101b is switched to the screen illustrated in FIG. 27. The determination of the machining region is the processing in step S5 in the flow of FIG. 4.

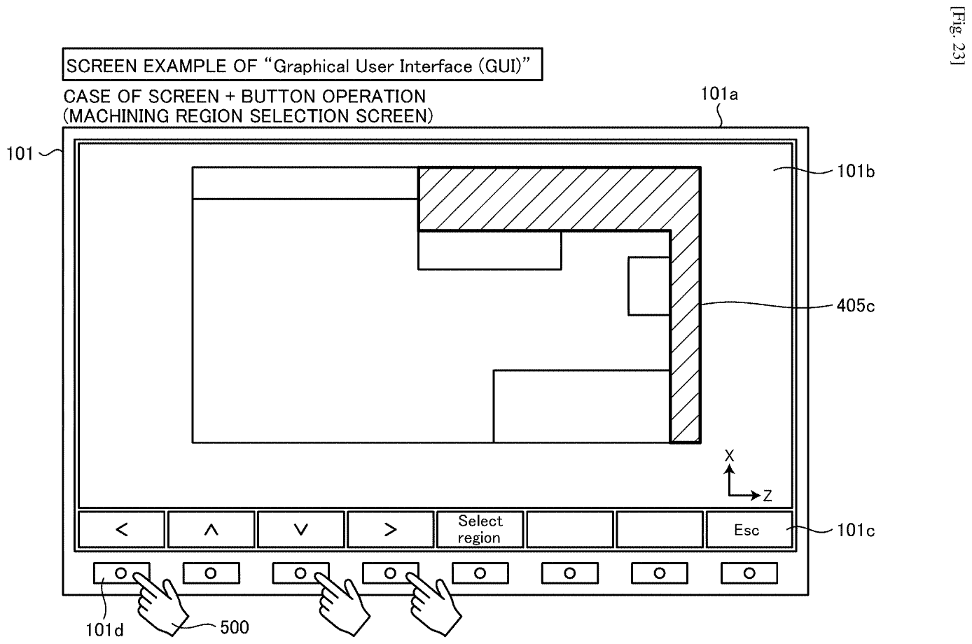

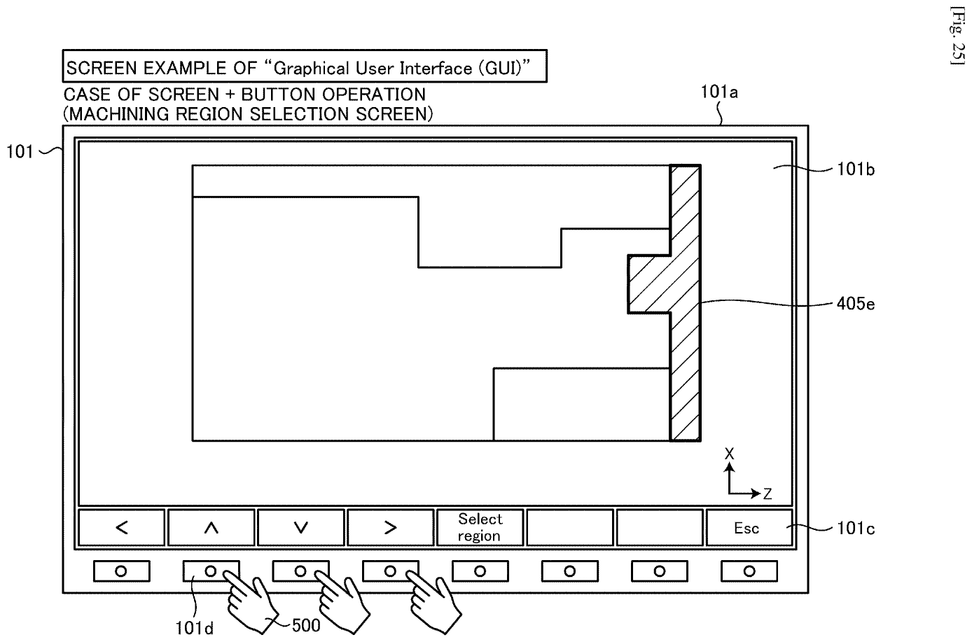

In the screen in FIG. 22, as the “second candidate” of the machining region 404, a machining region candidate 405b is displayed. The machining region candidate 405b is the machining region 404 configured by combining the sub-remaining regions 403c, 403d, 403f, 403g, 403j, and 403l in FIG. 17. When the user 500 operates the button 101d corresponding to the operation explanation presentation portion 101c displayed as “>” in the screen in FIG. 22, the screen on the main display 101b returns to the screen indicating the “first candidate” illustrated in FIG. 21. On the other hand, when the user 500 operates the button 101d corresponding to the operation explanation presentation portion 101c displayed as “<” in the screen in FIG. 22, the screen on the main display 101b is switched to a screen indicating a “third candidate” illustrated in FIG. 23. Moreover, when the user 500 operates the button 101d corresponding to the operation explanation presentation portion 101c displayed as “V” in the screen in FIG. 22, the screen on the main display 101b is switched to a screen indicating a “fifth candidate” illustrated in FIG. 25.

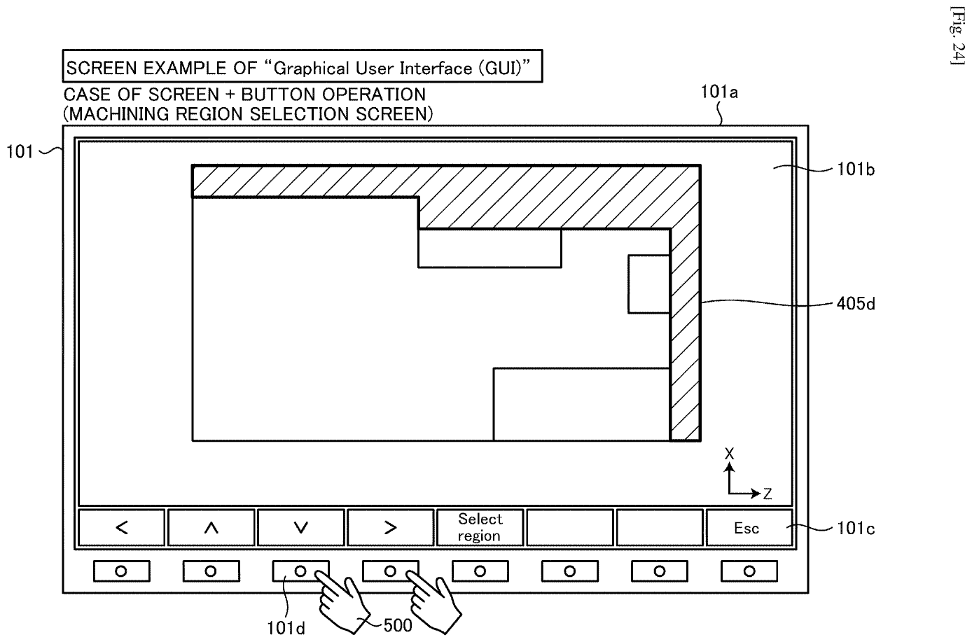

In the screen in FIG. 23, as the “third candidate” of the machining region 404, a machining region candidate 405c is displayed. The machining region candidate 405c is the machining region 404 configured by combining the sub-remaining regions 403b, 403c, 403d, 403e, 403f, 403g, 403j, and 403l in FIG. 17. When the user 500 operates the button 101d corresponding to the operation explanation presentation portion 101c displayed as “>” in the screen in FIG. 23, the screen on the main display 101b returns to the screen indicating the “second candidate” illustrated in FIG. 22. On the other hand, when the user 500 operates the button 101d corresponding to the operation explanation presentation portion 101c displayed as “<” in the screen in FIG. 23, the screen on the main display 101b is switched to a screen indicating a “fourth candidate” illustrated in FIG. 24. Moreover, when the user 500 operates the button 101d corresponding to the operation explanation presentation portion 101c displayed as “V” in the screen in FIG. 23, the screen on the main display 101b is switched to a screen indicating a “fifth candidate” illustrated in FIG. 25.

In the screen in FIG. 24, as the “fourth candidate” of the machining region 404, a machining region candidate 405d is displayed. The machining region candidate 405d is the machining region 404 configured by combining the sub-remaining regions 403a, 403b, 403c, 403d, 403e, 403f, 403g, 403j, and 403l in FIG. 17. When the user 500 operates the button 101d corresponding to the operation explanation presentation portion 101c displayed as “>” in the screen in FIG. 24, the screen on the main display 101b returns to the screen indicating the “third candidate” illustrated in FIG. 23. When the user 500 operates the button 101d corresponding to the operation explanation presentation portion 101c displayed as “V” in the screen in FIG. 24, the screen on the main display 101b is switched to the screen indicating the “fifth candidate” illustrated in FIG. 25.

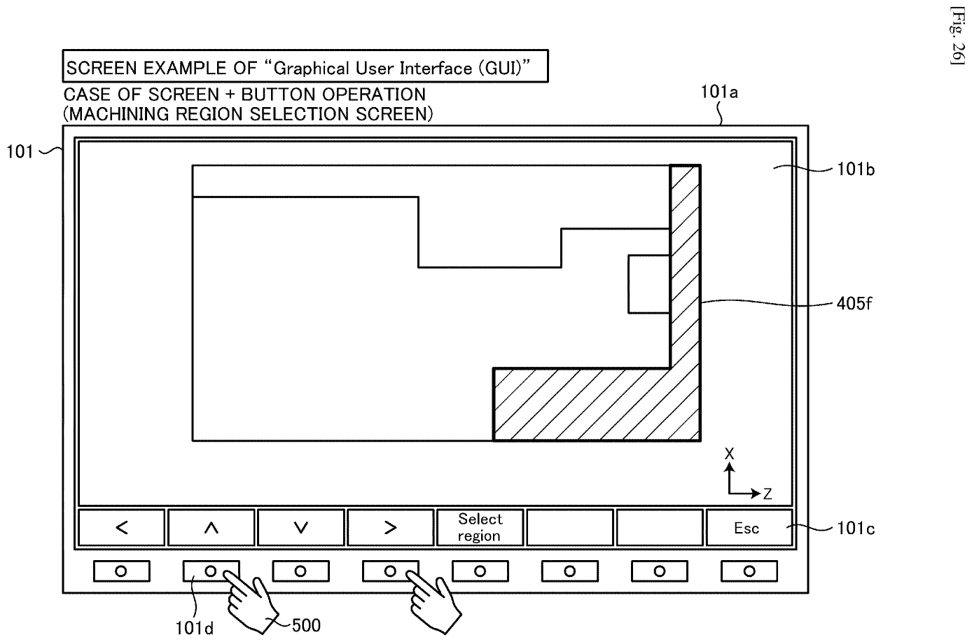

In the screen in FIG. 25, as the “fifth candidate” of the machining region 404, a machining region candidate 405e is displayed. The machining region candidate 405e is the machining region 404 configured by combining the sub-remaining regions 403d, 403g, 403i, 403j, and 403l in FIG. 17. When the user 500 operates the button 101d corresponding to the operation explanation presentation portion 101c displayed as “A” in the screen in FIG. 25, the screen on the main display 101b returns to the screen indicating the “second candidate” illustrated in FIG. 22. When the user 500 operates the button 101d corresponding to the operation explanation presentation portion 101c displayed as “>” in the screen in FIG. 25, the screen on the main display 101b returns to the screen indicating the “first candidate” illustrated in FIG. 21. When the user 500 operates the button 101d corresponding to the operation explanation presentation portion 101c displayed as “V” in the screen in FIG. 25, the screen on the main display 101b is switched to a screen indicating a “sixth candidate” illustrated in FIG. 26.

In the screen in FIG. 26, as the “sixth candidate” of the machining region 404, a machining region candidate 405f is displayed. The machining region candidate 405f is the machining region 404 configured by combining the sub-remaining regions 403d, 403g, 403j, 403k, and 403l in FIG. 17. When the user 500 operates the button 101d corresponding to the operation explanation presentation portion 101c displayed as “>” in the screen in FIG. 26, the screen on the main display 101b returns to the screen indicating the “first candidate” illustrated in FIG. 21. When the user 500 operates the button 101d corresponding to the operation explanation presentation portion 101c displayed as “A” in the screen in FIG. 26, the screen on the main display 101b is switched to the screen indicating the “fifth candidate” illustrated in FIG. 25.

It is assumed that the user 500 operate the button 101d corresponding to the operation explanation presentation portion 101c displayed as “>” in the screen in FIG. 26. Then, the screen on the main display 101b returns to the screen indicating the “first candidate” illustrated in FIG. 21. When the user 500 operates the button 101d corresponding to the operation explanation presentation portion 101c displayed as “Select region (select machining region)” in the screen in FIG. 21, the machining region candidate 405a of the “first candidate” is selected as the machining region, and the screen on the main display 101b is switched to the screen illustrated in FIG. 27. The determination of the machining region is the processing in step S5 in the flow of FIG. 4.

Furthermore, for the machining region candidate 405a selected as the machining region 404, a machining process is developed by the machining process development unit 105 in FIG. 1 according to the flow in FIG. 9. In the machining region candidate 405a, the shape pattern is an end surface position, and the machining direction is the end surface direction. Therefore, the machining process development unit 105 selects, for example, the “end surface machining” (refer to FIG. 10), as the machining process that can machine the machining region candidate 405a, from among the plurality of machining processes stored in the machining process information storage unit 108. Moreover, the machining process development unit 105 extracts items of the machining process parameters required for the “end surface machining” stored in the machining process information storage unit 108. Then, the machining process development unit 105 sets a value to each of the extracted items of the machining process parameters (start point X, start point Z, end point X, end point Z, or the like), based on shape data of the machining region candidate 405a. As a result, a machining process for machining the machining region candidate 405a is determined, and the machining process is output from the machining process output unit 106 as the machining program 107.

In the screen in FIG. 27, since the machining region candidate 405a of which the machining process has been already developed by the machining process development unit 105 in FIG. 1 is the machining region 404c of which the machining process has been developed, the machining region candidate 405a is indicated by the broken line. The remaining region division unit 104 extracts the actual remaining region 403, using the shape of the machining region 404c of which the machining process has been developed and the initial remaining region 403 extracted by the remaining region extraction unit 103 in FIG. 1. In this way, the remaining region 403 is updated to the actual remaining region 403. In the example in FIG. 27, the actual remaining region 403 includes three remaining regions 403A to 403C. In this way, the processing for updating the actual remaining region 403 by the remaining region division unit 104 is the processing in step S6 in the flow of FIG. 4. In the first embodiment, each time when the user 500 selects one machining region, the remaining region 403 is constantly updated to the latest remaining region 403. Furthermore, as illustrated in FIG. 27, the updated remaining region 403 is displayed on the screen of the user interface 101a of the GUI unit 101. As a result, the user 500 can easily select the machinable machining region using the screen of the user interface 101a. Furthermore, as indicated in step S7 in the flow of FIG. 4, the processing in steps S1 to S6 in the flow of FIG. 4 is repeated until the remaining region 403 disappears.

FIGS. 27 to 29 are screen examples for the user 500 to select the remaining region 403 in step S1 in the flow of FIG. 4. FIGS. 27 to 29 respectively illustrate the remaining regions 403A to 403C that are candidates of the remaining region to be selected as the remaining region 403 by the user 500.

For example, it is assumed that the user 500 select the remaining region 403A in the screen in FIG. 27. In this case, the remaining region division unit 104 generates a plurality of machining region candidates by arbitrarily combining the sub-remaining regions 403a, 403b, 403c, 403e, 403f, and 403h illustrated in FIG. 17, for each machining direction. These machining region candidates are sequentially displayed on the screen of the user interface 101a of the GUI unit 101. When the user 500 selects one candidate from among these machining region candidates, a machining process is determined for the candidate. By repeating this processing, the machining process is determined for all the sub-remaining regions 403a to 403l included in the initial remaining region 403. The series of determined machining processes forms the machining program for generating the final product shape 402 from the blank shape 401.

As described above, the machining process development support device 100 according to the first embodiment supports selection and development of a machinable machining process, based on the selection of the remaining region 403. In the machining process development support device 100, as illustrated in FIGS. 4 and 5, by only selecting the machining direction using the GUI unit 101 by the user 500, a candidate of a machining region that can be machined from the machining direction is displayed on the screen. When the user 500 selects one machining region from among these machining region candidates, the machining process development unit 105 extracts a machining process and a tool that can machine the machining region from the machining process information storage unit 108, based on the shape information of the machining region. Therefore, in the machining process development support device 100, the user 500 does not need to select the tool and the machining process to be used, and the tool and the machining process to be used are automatically selected, based on the shape information of the selected machining region. As a result, a load of the user 500 is largely reduced as compared with PTL 1 described above.

Furthermore, in the machining process development support device 100 according to the first embodiment, each time when the machining process of one machining region is developed, the actual remaining region 403 indicating the machining region that has not been developed yet is updated. In this way, in the machining process development support device 100, the current remaining region 403 is constantly updated, and the actual remaining region 403 is displayed on the screen by the GUI unit 101. Therefore, the user 500 can easily select the machining region that has not been developed yet, from the remaining region 403.

Since the machining program of PTL 1 described above does not consider an actual blank shape, a user has needed to manually edit the automatically generated program. On the other hand, in the first embodiment, the machining process development support device 100 includes the shape input unit 102 that accepts the input of the actual blank shape 401 and the final product shape 402. Therefore, the machining process development support device 100 can obtain the accurate remaining region 403, based on the actual blank shape 401 and the final product shape 402. Furthermore, since the machining process is determined and the machining program is generated based on the accurate remaining region 403, the user 500 does not need to manually edit the machining program.

Furthermore, in the machining process development support device 100 according to the first embodiment, the machining process development unit 105 develops the machining process based on the shape information of the machining region 404. The shape information of the machining region 404 includes the shape pattern of the machining region 404 and the value of the machining process parameter used in the machining process. Furthermore, in the machining process development support device 100 according to the first embodiment, the machining process information storage unit 108 stores the plurality of machining processes and the items of the machining process parameters required for these machining processes in advance. Therefore, the machining process development unit 105 extracts one or the plurality of machining processes that can the machining region 404, from among the plurality of machining processes stored in the machining process information storage unit 108, based on the shape information of the machining region 404. Moreover, the machining process development unit 105 sets the value of the machining process parameter to each of the items of the machining process parameters stored in the machining process information storage unit 108, based on the shape information of the machining region 404. In this way, in the machining process development support device 100 according to the first embodiment, the user 500 does not need to specify the tool and the machining process, and the machining process development unit 105 automatically determines the machining process based on the shape information of the machining region 404 and further sets the value of the machining process parameter required for the machining process. As a result, the machining program can be easily generated.

Next, a hardware configuration for implementing the machining process development support device 100 will be described. FIG. 30 is a diagram illustrating the hardware configuration for implementing the machining process development support device according to the first embodiment. As illustrated in FIG. 30, the machining process development support device 100 includes the input device 1001, a processing circuit 1004 including a processor 1002 and a memory 1003, the display 1005, and a transmission/reception device 1006 as hardware. Among the modules of the machining process development support device 100 illustrated in FIG. 1, the shape input unit 102, the remaining region extraction unit 103, the remaining region division unit 104, the machining process development unit 105, and a part of the machining process output unit 106 are implemented by the processor 1002 and the memory 1003. Furthermore, the machining process information storage unit 108 is implemented by the memory 1003. The processor 1002 and the memory 1003 form the processing circuit 1004. Furthermore, a part of the GUI unit 101 in FIG. 1 is implemented by the input device 1001. The input device 1001 includes, for example, a mouse, a keyboard, a touch panel, or the like. Another part of the GUI unit 101 in FIG. 1 is implemented by the display 1005. Another part of the machining process output unit 106 is implemented by the transmission/reception device 1006.

The processor 1002 is a central processing unit (CPU). The processor 1002 may be an arithmetic device, a microprocessor, a microcomputer, or a digital signal processor (DSP). The memory 1003 is, for example, a nonvolatile or volatile memory such as a random access memory (RAM), a read only memory (ROM), a flash memory, an erasable programmable read only memory (EPROM), or the like.

The memory 1003 stores a support program for implementing the machining process development support method. The processor 1002 reads the support program from the memory 1003 and executes the support program so as to implement functions of the modules in FIG. 1 described above. Moreover, when the processor 1002 executes each function, the memory 1003 is used also as a temporary memory. Note that the support program executed by the processor 1002 may be provided in a state of being stored in a storage medium. In that case, the storage medium is attached to the machining process development support device 100, and the support program is copied to the memory 1003. Alternatively, the support program can be downloaded from another computer or a cloud computer system to the memory 1003 via another communication path such as a local area network (LAN) cable or the Internet.

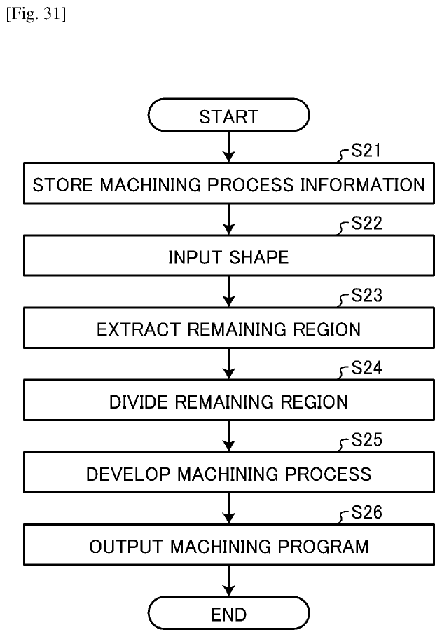

FIG. 31 is a flowchart illustrating a flow of processing of the machining process development support method according to the first embodiment. As illustrated in FIG. 31, in step S21, the plurality of machining processes is stored in the machining process information storage unit 108 in advance. In step S22, inputs of the shape data of the blank shape 401 and the final product shape 402 are accepted using the shape input unit 102. In step S23, the remaining region 403 is extracted based on the blank shape 401 and the final product shape 402. In step S24, the remaining region 403 is divided into the plurality of machining regions 404. In step S25, the development of the machining process is supported based on the shape information of the machining region 404. In step S26, the developed machining process is output as the machining program. Since the details of the processing in each step are as described above in the description of the machining process development support device 100, here, description thereof is omitted.

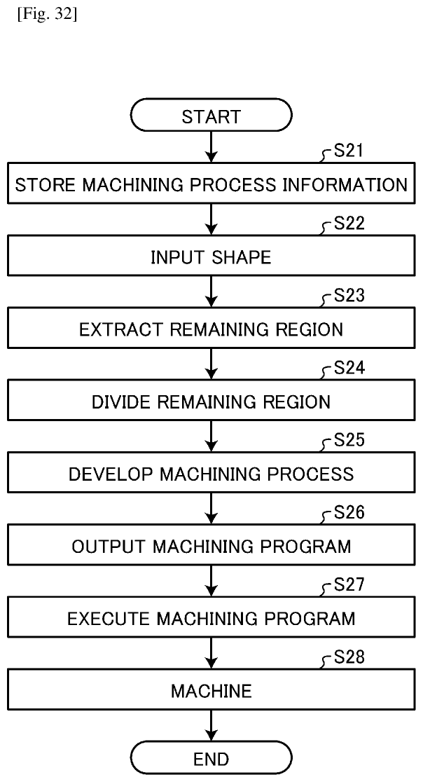

FIG. 32 is a flowchart illustrating a flow of processing of the machining method according to the first embodiment. As illustrated in FIG. 32, in the machining method, steps S27 and S28 are further added to steps S21 to S26 in FIG. 31. Since steps S21 to S26 are the same as those in FIG. 31, the description thereof is omitted. In step S27, the machining program 107 is executed, the machining command is generated, and the control signal indicating the machining command is generated. In step S28, the driving unit 301 of the machining device 300 drives the tool 302 according to the control signal, and the workpiece 400 is machined. Since the details of the processing in each step are as described above in the description of the machining process development support device 100, the numerical control device 200, and the machining device 300, here, the description thereof is omitted.

The configurations illustrated in the above embodiment indicate examples and can be combined with other known techniques. Furthermore, the embodiments can be combined with each other, and the configurations can be partially omitted or changed without departing from the scope of the present invention.

### REFERENCE SIGNS LIST

100 machining process development support device
101 GUI unit
101a user interface
101b main display
101c operation explanation presentation portion
101d button
102 shape input unit
103 remaining region extraction unit
104 remaining region division unit
105 machining process development unit
106 machining process output unit
107, 107a, 107b, 107c, 107d machining program
108 machining process information storage unit
200 numerical control device
300 machining device
301 driving unit
302 tool
400 workpiece
401 blank shape
402 final product shape
402a end surface portion
402b hole
402c groove
402d constricted portion
402e first end portion
402f second end portion
403, 403A, 403B, 403C remaining region
403a, 403b, 403c, 403d, 403e, 403f, 403g, 403h, 403i, 403j, 403k, 403l sub-remaining region
404, 404a, 404b, 404c machining region
405a, 405b, 405c, 405d, 405e, 405f machining region candidate
500 user
600 machining process development support system
700 machining system
800 central axis
1001 input device
1002 processor
1003 memory
1004 processing circuit
1005 display
1006 transmission/reception device

1. A machining process development support device comprising:
shape input circuitry that accepts input of shape data of a blank shape and a final product shape;
remaining region extraction circuitry that extracts remaining regions that are regions to be machined based on the blank shape and the final product shape input through the shape input circuitry;
remaining region division circuitry that divides the remaining regions extracted by the remaining region extraction circuitry into a plurality of machining regions;
machining process development circuitry that supports development of machining processes that machine the machining regions based on shape information of the machining regions formed by the remaining region division circuitry; and
machining process output circuitry that outputs, as a machining program, the machining processes developed with the support of the machining process development circuitry.

2. The machining process development support device according to claim 1,
wherein the machining process development circuitry stores, into a machining process information storage circuitry, machining process information including a plurality of machining processes as well as items of their required machining process parameters in advance;
extracts, from the plurality of machining processes stored into the machining process information storage circuitry, one or more machining processes that enables each of the machining regions formed by the remaining region division circuitry to be machined, based on the shape information of the machining regions; and
sets values of the machining process parameters for each of the machining regions according to the machining process information stored into the machining process information storage circuitry and the shape information of the machining regions.

3. The machining process development support device according to claim 1, wherein the remaining region division circuitry extracts an actual remaining region using the remaining regions extracted by the remaining region extraction circuitry and a shape of the machining regions for which the machining process has been already developed by the machining process development circuitry.

4. The machining process development support device according to claim 3, further comprising:
GUI circuitry that includes a user interface to deal with the instructions of a user,
wherein the GUI circuitry displays, with the user interface, the remaining regions extracted by any one of the remaining region extraction circuitry and the remaining region division circuitry.

5. The machining process development support device according to claim 4, wherein the remaining region division circuitry extracts one or more machining directions in which the remaining regions are machinable for each of the remaining regions displayed with the user interface so as to display the machining directions on the user interface;
when the remaining region division circuitry receives through the user interface the instructions of the user for selecting one machining direction among the machining directions, the remaining region division circuitry extracts, as the machining regions, one or more remaining regions that are machinable in the machining directions selected by the instructions of the user so as to display the machining regions on the user interface.

6. The machining process development support device according to claim 5, wherein, when the remaining region division circuitry receives through the user interface the instructions of the user for selecting one machining region among the machining regions, the remaining region division circuitry outputs, to the machining process development circuitry, the machining region selected.

7. A machining process development support system comprising:
the machining process development support device according to claim 1; and
a numerical control device that receives a machining program sent from the machining process development support device, executes the machining program to generate machining commands, creates control signals that indicate the machining commands, and outputs the control signals.

8. A machining system comprising:
the machining process development support device according to claim 1;
a numerical control device that receives a machining program sent from the machining process development support device, executes the machining program to generate machining commands, creates control signals that indicate the machining commands, and sends the control signals; and
a machining device that includes a machining tool, receives the control signals and drives the machining tool in accordance with the control signals to machine a workpiece.

9. A machining process development support method comprising:
storing, into a machining process information storage circuitry, a plurality of machining processes in advance;
accepting input of shape data including a blank shape and a final product shape;
extracting remaining regions based on the blank shape and the final product shape;
dividing the remaining regions into a plurality of machining regions;
supporting development of machining processes using shape information of the machining regions; and
outputting as machining program the machining process developed.

10. A machining method comprising:
the machining process development support method according to claim 9;
executing the machining program to generate machining commands and creating control signals that indicate the machining commands; and
driving a machining tool in accordance with the control signals to machine a workpiece.

11. The machining process development support device according to claim 2, wherein the remaining region division circuitry extracts an actual remaining region using the remaining regions extracted by the remaining region extraction circuitry and a shape of the machining regions for which the machining process has been already developed by the machining process development-circuitry.

12. The machining process development support device according to claim 11, further comprising:
GUI circuitry that includes a user interface to deal with the instructions of a user,
wherein the GUI circuitry displays, with the user interface, the remaining regions extracted by any one of the remaining region extraction circuitry and the remaining region division circuitry.

13. The machining process development support device according to claim 12, wherein the remaining region division circuitry extracts one or more machining directions in which the remaining regions are machinable for each of the remaining regions displayed with the user interface so as to display the machining directions on the user interface;
when the remaining region division circuitry receives through the user interface the instructions of the user for selecting one machining direction among the machining directions, the remaining region division circuitry extracts, as the machining regions, one or more remaining regions that are machinable in the machining directions selected by the instructions of the user so as to display the machining regions on the user interface.

14. The machining process development support device according to claim 13, wherein, when the remaining region division circuitry receives through the user interface the instructions of the user for selecting one machining region among the machining regions, the remaining region division circuitry outputs, to the machining process development circuitry, the machining region selected.
